(19) United States
(12) Patent Application Publication
(10) Pub. No.: US 2008/0040392 A1
(43) Pub. Date: Feb. 14, 2008

(54) IMAGE PROCESSING APPARATUS, IMAGE FORMING APPARATUS, PROGRAM MANAGEMENT METHOD, AND MANAGEMENT PROGRAM FOR MANAGING PROGRAMS

(76) Inventor: Satoru Sugishita, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/828,051

(22) Filed: Jul. 25, 2007

(30) Foreign Application Priority Data
Aug. 10, 2006 (JP) 2006-218426

(51) Int. Cl. G06F 17/30

(52) U.S. Cl. 707/104.1; 707/E17.004

(57) ABSTRACT

There is disclosed an image processing apparatus in which plural programs mutually having dependence and dependence information indicating the dependence between the programs are stored. The apparatus includes a configuration management unit that generates hierarchical structure information, where the dependence between the programs is stratified, based on the dependence information; a hierarchical structure information table in which the hierarchical structure information is stored; and an operations management unit that performs at least one of starting, termination, installation, and uninstallation of the programs by using the hierarchical structure information table.

### BACKGROUND OF THE INVENTION

1. Field of the Invention

The present invention relates to an image processing apparatus, an image forming apparatus, a program management method, and a management program for managing programs.

2. Description of the Related Art

Present MFPs (multi-function peripherals) have functions not only as a digital copier, but also as a facsimile, a printer, a scanner, etc., due to technological advances associated with MFPs (hereinafter referred to as “image processing apparatus”) such as improved CPU (Central Processing Unit) performance, increased memory capacity, accelerated communication technology, and highly-developed digital imaging technology. Hence, they are used in many situations depending on users' circumstances.

For this reason, users often request functional expansion to suit their needs, causing relevant manufacturers to feel obligated to develop an image processing apparatus excellent in function expandability and introduction flexibility for prompt functional expansion.

Among the methods proposed in view of the above points, there is, for example, one in which a function to be expanded is selected from a download server storing programs of expanded functions, and a desired program and authentication information are downloaded (are transferred to an image processing apparatus) to execute the program based on the downloaded authentication information (see, e.g., Patent Document 1).
(Patent Document 1) JP-A-2002-152458

### SUMMARY OF THE INVENTION

The method of JP-A-2002-152458 is effective in that it promptly introduces newly-developed expanded functions, but the following problems remain unsolved involving function expandability, function introduction flexibility, and product performance quality.

Present image processing apparatuses have a centrally-located program in their systems that manages the specifications of all the introduced expanded functions, constituting an overconcentrated structure in which the management program handles the program configuration of all the expanded functions and manages the operations thereof.

In terms of expandability, when a newly-developed expanded function is introduced, it is therefore necessary to change the program code of the management program on a case-by-case basis, thereby causing inefficient expandability of the apparatuses.

In terms of flexibility, on the other hand, expanded functions are not necessarily developed by developers with thorough knowledge of image processing apparatuses. It is possible, therefore, that the programs of expanded functions are provided by manufacturers including third party vendors without being supplied by the users' company. Due to the high dependence between the programs of expanded functions and the program management section, it is difficult to introduce the expanded functions, with the result that no flexibility is allowed in the apparatuses.

Furthermore, it is difficult to transplant functions into plural image processing apparatuses having different platforms for the same reason, with the result that no flexibility is allowed in the apparatuses.

Besides, in the overconcentrated structure, it becomes complicated to manage the starting, terminating, adding, and deleting of expanded functions in a situation where multiple expanded functions are introduced, and it is difficult to manage respective functions. The complicated management could adversely affect the processing performance of the apparatuses.

As described above, it is considered that high dependence between the programs of expanded functions and the program management section degrades function expandability, function introduction flexibility, and product performance quality.

In view of the problems of the above-described related art, the present invention has an object of providing an image processing apparatus; an image forming apparatus; a program management method; and a management program for managing programs, which stratifies the dependence of plural programs and manages the operations of the programs in accordance with the result of hierarchization.

To this end, according to the present invention, there is provided an image processing apparatus in which plural programs mutually having dependence and dependence information indicating the dependence between the programs are stored. The apparatus comprises a configuration management unit that generates hierarchical structure information, where the dependence between the programs is stratified based on the dependence information; a hierarchical structure information table in which the hierarchical structure information is stored; and an operations management unit that performs at least one of starting, termination, installation, and uninstallation of the programs by using the hierarchical structure information table.

With this configuration, the image processing apparatus stratifies the dependence of the programs based on the dependence information, stores the hierarchical structure information as stratified information in the hierarchical structure information table (generates the hierarchical structure information), and operates the programs of expanded functions in accordance with the hierarchical structure information when performing starting or termination. Therefore, it is possible to facilitate the management of the expanded functions due to the low dependence between the programs of the expanded functions and function sections that manage the programs.

Accordingly, it is possible to achieve a system excellent in function expandability, function introduction flexibility, and product performance quality.

To this end, according to the image processing apparatus of the present invention, when a predetermined program is started, the operations management unit requests the configuration management unit to acquire the hierarchical structure information and starts a program that the predetermined program uses based on the acquired hierarchical structure information.

With this configuration, the image processing apparatus can start the programs of the expanded functions mutually having the dependence (using side/used side) based on the acquired hierarchical structure information.

To this end, according to the image processing apparatus of the present invention, when terminating a predetermined program, the operations management unit requests the configuration management unit to acquire the hierarchical structure information and requests a program that the predetermined program uses to terminate based on the acquired hierarchical structure information.

With this configuration, the image processing apparatus can terminate the programs of the expanded functions mutually having the dependence (using side/used side) based on the acquired hierarchical structure information.

To this end, according to the image processing apparatus of the present invention, the operations management unit requests the configuration management unit to perform installation or uninstallation when installing or uninstalling, respectively, the programs.

With this configuration, the image processing apparatus performs installation or uninstallation by issuing instructions for the installation or uninstallation through the process of managing the operations of the programs, thereby making it possible to manage the operations of the programs without handling the program configuration of the expanded functions.

To this end, according to the image processing apparatus of the present invention, the configuration management unit updates the hierarchical structure information table when the programs are installed or uninstalled.

With this configuration, the image processing apparatus automatically updates the hierarchical structure information of the hierarchical structure information table when performing installation or uninstallation, thereby making it possible to manage information on the latest program configuration installed.

To this end, according to the image processing apparatus of the present invention, the configuration management unit replies with the hierarchical structure information based on the hierarchical structure information table when an acquisition of the hierarchical structure information is requested.

With this configuration, the image processing apparatus replies the hierarchical structure information in response to the acquisition request of the hierarchical structure information, thereby making it possible to acquire information on the latest hierarchical structure.

To this end, the image processing apparatus of the present invention comprises a display unit that displays information on the programs on a display screen; and an authentication unit that authenticates whether a user is authorized to view the information on the programs. The display unit displays the information on the programs when the authentication unit succeeds in authentication.

With this configuration, the image processing apparatus displays on the display screen the information on the programs of the expanded functions for the authorized user, thereby making it possible to restrict the user and disclose the information on the programs of the installed expanded functions.

To this end, according to image processing apparatus of the present invention, the authentication unit determines reference authority indicating an available range of information among information items on the programs for each authenticated user.

With this configuration, the image processing apparatus determines authority indicating the available range of the information on the programs of the expanded functions for each user, thereby making it possible to restrict the available range of the information on the programs of the expanded functions for each authorized user.

To this end, according to the image processing apparatus of the present invention, the display unit displays the information on the programs within the range restricted based on the reference authority.

With this configuration, the image processing apparatus displays on the display screen the information on the programs of the expanded functions within the restricted range based on the authority set for each user, thereby making it possible to disclose the information on the programs of the expanded functions within the restricted range.

To this end, according to the present invention, there is provided an image forming apparatus comprising the image processing apparatus as defined in the claims.

With this configuration, the image forming apparatus includes the image processing apparatus having the capability to solve the problems as described above, thereby making it possible to achieve the same effect as that of the image processing apparatus.

To this end, according to the present invention, there is provided a program management method of an image processing apparatus in which plural programs mutually having dependence and dependence information indicating the dependence between the programs are stored. The method comprises a configuration management step of generating hierarchical structure information, where the dependence between the programs is stratified, based on the dependence information; and an operations management step of performing at least one of starting, termination, installation, and uninstallation of the programs by using a hierarchical structure information table in which the hierarchical structure information is stored.

With this configuration, the program management method stratifies the dependence of the programs based on the dependence information, stores the hierarchical structure information as stratified information in the hierarchical structure information table (generates the hierarchical structure information), and operates the programs of expanded functions in accordance with the hierarchical structure information, when performing starting or termination. Therefore, it is possible to facilitate the management of the expanded functions due to the low dependence between the programs of the expanded functions and function sections that manage the programs.

Accordingly, it is possible to manage the programs of the expanded functions to achieve a system excellent in function expandability, function introduction flexibility, and product performance quality.

To this end, according to the present invention, there is provided a management program for managing a plurality of programs in an image processing apparatus in which the plural programs mutually having dependence and dependence information indicating the dependence between the programs are stored. The program causes a computer to function as a configuration management unit that generates hierarchical structure information, where the dependence between the programs is stratified, based on the dependence information; a hierarchical structure information table in which the hierarchical structure information is stored; and an operations management unit that performs at least one of starting, termination, installation, and uninstallation of the programs by using the hierarchical structure information table.

With this configuration, the management program in a computer stratifies the dependence of the programs based on the dependence information, stores the hierarchical structure information as stratified information in the hierarchical structure information table (generates the hierarchical structure information), and operates the programs of expanded functions in accordance with the hierarchical structure information when performing starting or termination. Therefore, it is possible to facilitate the management of the expanded functions due to the low dependence between the programs of the expanded functions and function sections that manage the programs.

Accordingly, it is possible to operate the management program that manages the programs of the expanded functions to achieve a system excellent in function expandability, function introduction flexibility, and product performance quality in a computer.

According to the present invention, it is possible to provide an image processing apparatus; an image forming apparatus; a program management method; and a management program for managing programs, which stratifies dependence of plural programs based on dependence information, stores hierarchical structure information as stratified information in a hierarchical structure information table (generates the hierarchical structure information), and manages the operations of programs of expanded functions in accordance with the hierarchical structure information.

Furthermore, according to the present invention, the dependence of programs is stratified based on dependence information, the hierarchical structure information as stratified information is stored in the hierarchical structure information table (the hierarchical structure information is generated), and the programs of the expanded functions are operated in accordance with the hierarchical structure information, so as to perform starting or termination. Therefore, it is possible to facilitate the management of the expanded functions due to the low dependence between the programs of the expanded functions and function sections that manage the programs.

Furthermore, since a method of managing the programs of expanded functions is simplified, it is possible to reduce processing work loads to manage programs when plural functions are expanded.

Accordingly, it is possible to achieve a system excellent in function expandability, function introduction flexibility, and product performance quality.

### BRIEF DESCRIPTION OF THE DRAWINGS

FIG. 1 is a block diagram showing a hardware configuration example of an image processing apparatus according to a first embodiment of the present invention;

FIG. 2 is an illustration showing an example of the development operation for expanded functions using frameworks according to the first embodiment of the present invention;

FIG. 3 is an illustration showing an example in which the expanded-function package 30 according to the first embodiment of the present invention is stratified after being installed;

FIG. 4 are illustrations showing operational examples of the programs of the expanded functions according to the first embodiment of the present invention;

FIG. 5 is a block diagram showing a configuration example of a main function section according to the first embodiment of the present invention;

FIG. 6 is a block diagram showing a configuration example of the units of the main function section according to the first embodiment of the present invention;

FIG. 7 is an illustration showing a data configuration example of the hierarchical structure information table according to the first embodiment of the present invention;

FIG. 8 is an illustration showing an example of updating contents of the hierarchical structure information table at the installation/uninstallation according to the first embodiment of the present invention;

FIG. 9 is a flowchart showing a process regarding the program start function of the programs of the expanded functions according to the first embodiment of the present invention;

FIG. 10 is a flowchart showing a process regarding the program terminating function of the programs of the expanded functions according to the first embodiment of the present invention;

FIG. 11 is a flowchart showing a process regarding the expanded-functions operation management section according to the first embodiment of the present invention;

FIG. 12 is a flowchart showing a process regarding the program configuration management section according to the first embodiment of the present invention;

FIG. 13 is a flowchart showing a process regarding the authentication section according to the first embodiment of the present invention;

FIG. 14 is a flowchart showing a displaying process according to the first embodiment of the present invention;

FIG. 15 is a sequence diagram showing the flow of starting a first expanded function according to the first embodiment of the present invention;

FIG. 16 is a sequence diagram showing the flow of starting a second expanded function according to the first embodiment of the present invention;

FIG. 17 is a sequence diagram showing the flow of terminating the first expanded function according to the first embodiment of the present invention;

FIG. 18 is a sequence diagram showing the flow of installing the first and second expanded functions according to the first embodiment of the present invention;

FIG. 19 is a sequence diagram showing the flow of uninstalling the first expanded function according to the first embodiment of the present invention;

FIG. 20 is a sequence diagram showing the flow of displaying the hierarchical structure information on the first and second expanded functions according to the first embodiment of the present invention;

FIG. 21 is an illustration showing a display example (when the user has low-level authority) of the hierarchical structure information on the first and second expanded functions according to the first embodiment of the present invention;

FIG. 22 is an illustration showing a display example (when the user has high-level authority) of the hierarchical structure information on the first and second expanded functions according to the first embodiment of the present invention; and

FIG. 23 is a block diagram showing a hardware configuration example according to the modified example of the present invention.

### DETAILED DESCRIPTION OF THE PREFERRED EMBODIMENTS

Referring to the accompanying drawings, a description is made below of preferred embodiments of the present invention.

### First Embodiment

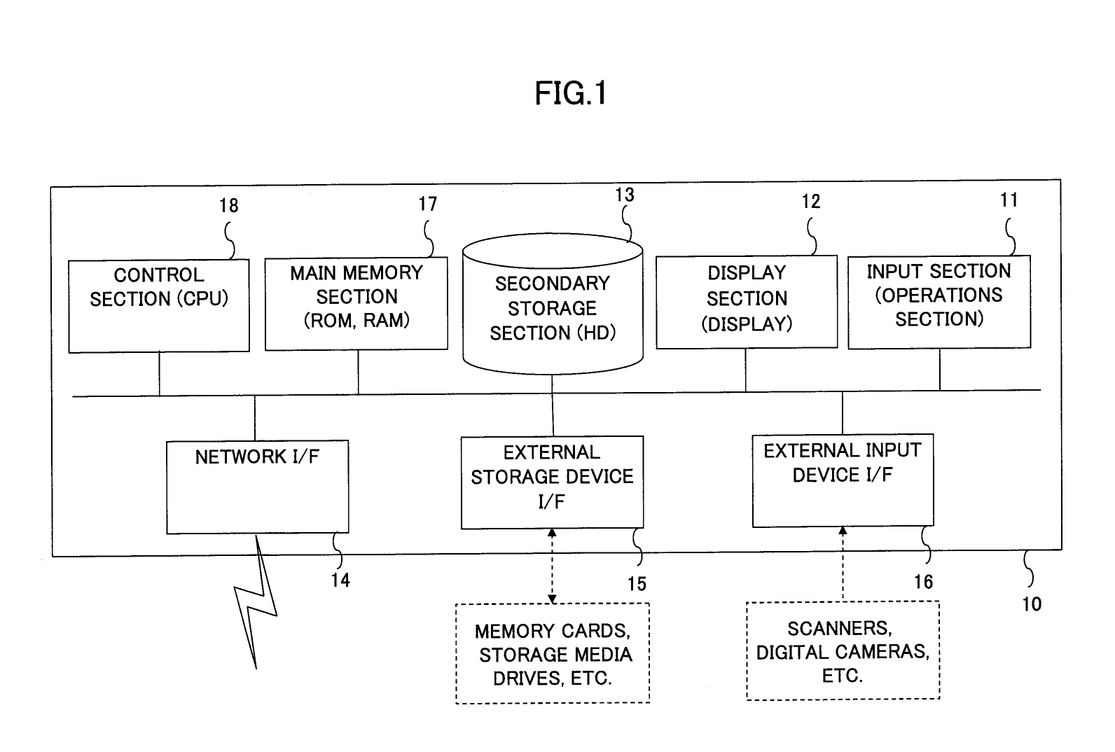

FIG. 1 is a block diagram showing a hardware configuration example of an image processing apparatus according to a first embodiment of the present invention.

As shown in FIG. 1, the image processing apparatus 10 includes an input section 11, a display section 12, a secondary storage section 13, a network I/F 14, an external storage device I/F 15, an external input device I/F 16, a main memory section 17, and a control section 18.

The input section 11 is called an operations section and includes a numeric keypad, various function keys, start/stop keys, and the like. The input section 11 receives with respective keys the inputs for setting various settings of image processing functions (for example, “resolution settings” with the numeric keypad, “magnification settings of magnification change”) and the inputs for selecting the execution of functions (for example, “execution of magnification change” with the start key). In the present embodiment, the input section 11 receives, by inputting, an identification code of the user, a password, and the like for user authentication as is described below.

The display section 12 includes liquid crystal display equipment and displays various information items such as information on jobs (for example, “job name during image processing”), conditions for driving the image processing apparatus 10 (for example, “set resolution value” or “set magnification”), and apparatus statuses (for example, “standby for job” or “job processing”). If the display section 12 is provided with a touch-panel function, it is possible to perform touch-input using a stylus or the like on a touch panel and an operation similar to that performed in the input section 11 by selecting the function button displayed on the panel. In the present embodiment, the display section 12 displays on a display screen information on the installed expanded functions as is described below when it is viewed by the user.

The secondary storage section 13 is a storage device such as a HD (Hard disk) in which data (for example, “image data”) handled by the image processing apparatus 10 are stored. In the present embodiment, the secondary storage section 13 stores the programs of expanded functions and the associated data.

The network I/F 14 is a hardware interface for two-way communication of data between communication equipment on the network, such as public lines and wireless circuits, and the image processing apparatus 10. In the present embodiment, the network I/F 14 is used as a network interface when the programs of expanded functions, the associated data, and the like to be installed are downloaded, for example, from a management server.

The external storage device I/F 15 is a hardware interface for transmission of data between external storage devices such as memory cards and the image processing apparatus 10. The external storage devices include storage media drives such as FDs (floppy disks), MOs (Magneto-Optical disks), CDs (Compact Disks), and DVDs (Digital Versatile Disks) besides memory cards. In the present embodiment, the external storage device I/F 15 is used as a data interface when the programs of expanded functions, the associated data, and the like stored in memory cards or recording media are transmitted.

The external input device I/F 16 is a hardware interface for transmission of data between image reading devices such as scanners and digital cameras and the image processing apparatus 10. In the present embodiment, image data for image processing are input to the external input device I/F 16 (image data are read by the external input device I/F 16).

The main memory section 17 is a memory circuit composed of ROM (Read Only Memory) and RAM (Random Access Memory). In the present embodiment, the main memory section 17 has stored in the ROM basic software (hereinafter referred to as an “OS (Operating System)”) for controlling the image processing apparatus 10 and the programs and the associated data of basic functions (for example, “an image input function,” “an image process function,” and “an image output function”) provided when the image processing apparatus 10 is started, and the programs and the data stored in the ROM are loaded into the RAM.

The control section 18 is called a controller section and includes the CPU. In the present embodiment, after the power of the image processing apparatus 10 is turned on, the control section 18 causes the programs and the data stored in the ROM to be loaded into the RAM as required and executes the loaded programs, to thereby start the OS and cause the basic functions to operate as applications on the started OS. Furthermore, when expanded functions are installed, the control section 18 causes the programs of expanded functions and the data stored in the secondary storage section 13 to operate as plug-in software on the started OS in the same manner as the programs of the basic functions.

The above-described hardware devices are connected to one another via a bus as a transmission path for signals and a connection cable. Accordingly, the control section 18 transmits control instruction signals to the input section 11, the display section 12, the secondary storage section 13, the network I/F 14, the external storage device I/F 15, the external input device I/F 16, and the main memory section 17. In response, the input section 11, the display section 12, the secondary storage section 13, the network I/F 14, the external storage device I/F 15, the external input device I/F 16, and the main memory section 17 transmit to the control section 18 the data signals processed by the respective sections and devices in accordance with the control instructions.

Accordingly, the control section 18 can control the entire operation of the image processing apparatus 10.

As described above, the image processing apparatus 10 can acquire the programs of expanded functions and the associated data to be installed via the network I/F 14 when they are stored in a management server on the network, and acquire the same via the external storage device I/F 15 when they are stored in memory cards or recording media so as to install the acquired programs and data (store them in the secondary storage section 13).

Furthermore, the control section 18 causes the programs of expanded functions and the associated data installed to be loaded from the secondary storage section 13 into the RAM of the main memory section 17 and executes the loaded programs, to thereby achieve the function expandability of the basic functions.

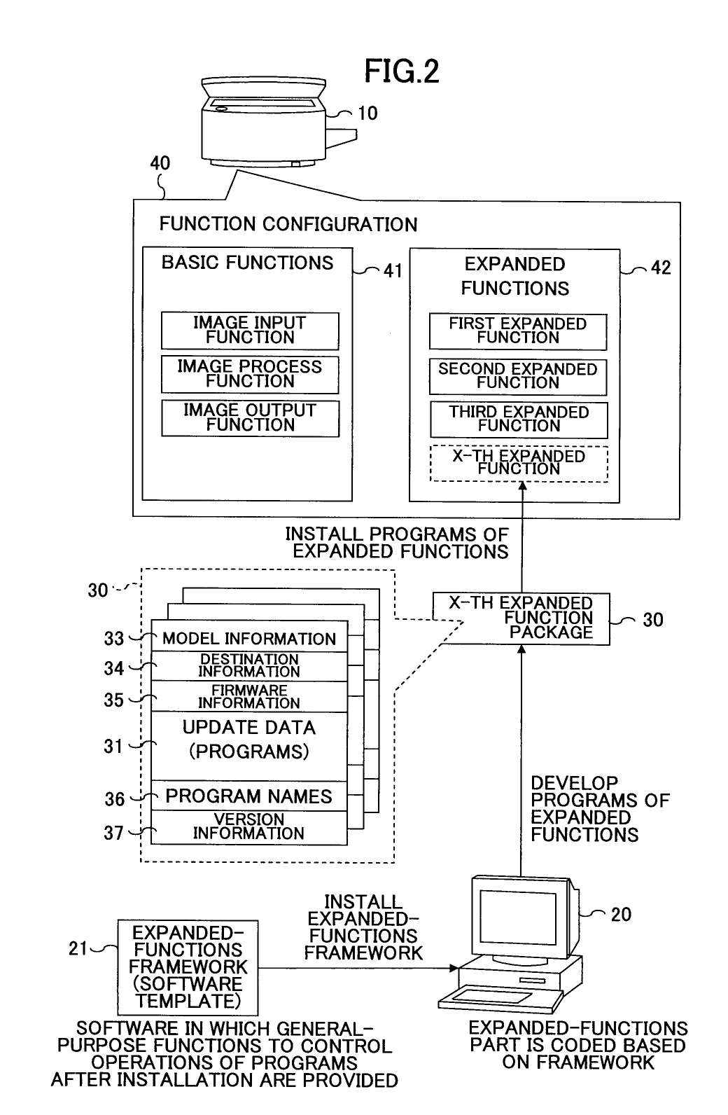

Referring next to FIG. 2, a description is made below about how expanded functions are developed and provided with respect to the image processing apparatus 10.

FIG. 2 is an illustration showing an example of the development operation for expanded functions using frameworks according to the first embodiment of the present invention.

First, a function configuration 40 of the image processing apparatus 10 is roughly composed of the basic functions 41 and the expanded functions 42.

As shown in FIG. 2, the basic functions 41 refer to the “image input function” for inputting image data, the “image process function” for processing input image data, and the “image output function” for outputting processed image data. That is, the basic functions 41 are composed of the functions required for processing the images of input data and outputting the processed image data.

The expanded functions 42 are composed of functions for expanding the above-described basic functions 41.

Accordingly, the basic functions 41 serve as function applications in the image processing apparatus 10, whereas the expanded functions 42 serve as plug-in software for the function applications.

The plug-in software of the expanded functions 42 is developed using a PC (Personal Computer) 20 provided with a development environment (for example, “compiler” and “debugger”) for developing the plug-in software as shown in FIG. 2 based on an expanded-functions framework 21 as a software template of the plug-in software.

In the expanded-functions framework 21, there is provided as one unit a programmed general-purpose function (that controls the operations of programs in accordance with operating rules) (hereinafter referred to as “an operations control function”) that controls the operations of programs to suit the specifications of the architecture and the platform employed in the image processing apparatus 10.

Therefore, the development operations for the plug-in software of the expanded functions 42 cannot be influenced by the specifications of the architecture and the platform of the image processing apparatus 1. The developer has only to make the designed expanded-functions section into program code to develop the plug-in software based on the expanded-functions framework 21 corresponding to the image processing apparatus 10.

The plug-in software of the expanded functions 42 thus developed is composed of header files for data identification of “model information 33,” “destination information 34,” and “firmware information 35” and of update data of “update data (programs) 31,” “program names 36,” and “version information 37” as shown in FIG. 2. The plug-in software is packaged on an expanded-functions basis; stored in the management server, memory cards, recording media, and the like as an expanded-function package 30; and provided to the image processing apparatus 10.

Accordingly, with the method of developing the plug-in software of the expanded functions 42 based on the expanded-functions framework 21 and providing the same with the image processing apparatus 10, it becomes possible to expand the functions of the software developed by manufacturers including third party vendors without the functions being supplied by the users' company and of the plug-in software of the new expanded functions 42 to be developed at low cost and in a prompt manner, thereby achieving a system excellent in flexibility.

Furthermore, as for the transplantation of functions between the image processing apparatuses 10 having different architectures and platforms as well, it is required only to transplant the expanded-functions section based on the expanded-functions framework 21 corresponding to the image processing apparatus 10 to which functions are transplanted, thereby making it possible to achieve the transplantation of the functions efficiently.

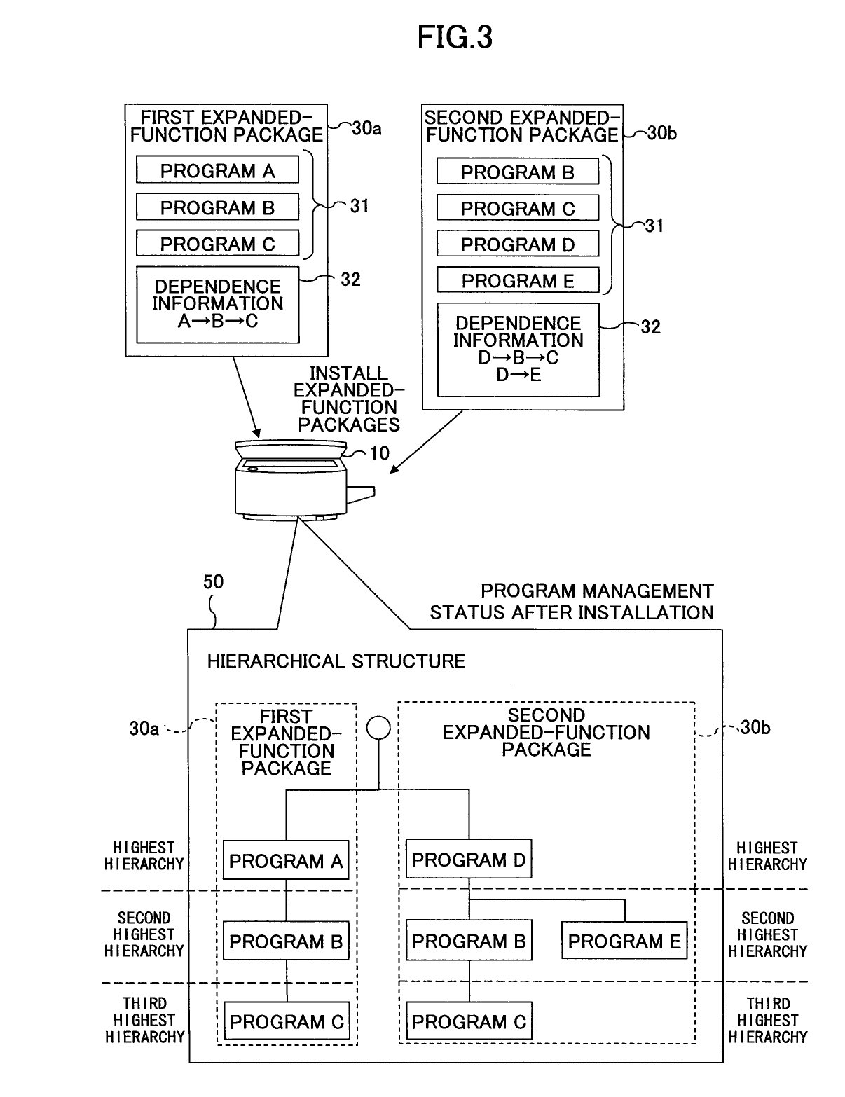

Referring next to FIG. 3, a description is made below about which programs and data constitute the expanded-function package 30 and how they are managed in the image processing apparatus 10 after being installed therein.

FIG. 3 is an illustration showing an example in which the expanded-function package 30 according to the first embodiment of the present invention is stratified after being installed.

First, as shown in FIG. 3, a first expanded-function package 30a and a second expanded-function package 30b are composed of programs 31 (programs A through E) to expand the functions of basic applications and dependence information 32 indicating the dependence between the programs.

“The dependence between the programs” herein refers to the relationships in which the operation of one program is defined and conditioned by one or more other programs, for example, such cases as “program B uses program A,” “program A is used by program B,” “program B calls program A,” or “program A is called by program B” between programs A and B. The dependence information 32 is composed of such dependence information between programs.

Next, after the first expanded-function package 30a and the second expanded-function package 30b are installed in the image processing apparatus 10, the program configuration thereof is managed by a hierarchical structure 50 as shown in FIG. 3.

In the case of the first expanded-function package 30a, for example, the dependence of programs A, B, and C is stratified such that program A, program B, and program C are positioned in the highest hierarchy (1), the second highest hierarchy (2), and the third highest hierarchy (3), respectively, based on the dependence (A→B→C) as shown in the dependence information 32.

Furthermore, in the case of the second expanded-function package 30b, the dependence of programs B, C, D, and E is stratified such that program D, programs B and E, and program C are positioned in the highest hierarchy (1), the second highest hierarchy (2), and the third highest hierarchy (3), respectively, based on the dependence (D→B→C, D→E) as shown in the dependence information 32.

As described above, the dependence between plural programs of the first expanded-function package 30a and the second expanded-function package 30b installed in the image processing apparatus 10 is stratified (hierarchies (1), (2), and (3)), to thereby make it possible to manage the program configuration of the packages.

As shown in FIG. 3, for example, when the first expanded-function package 30a is installed, the programs are so managed that programs A, B, and C are positioned in the highest hierarchy (1), the second highest hierarchy (2), and the third highest hierarchy (3), respectively.

Furthermore, when the second expanded-function package 30b is installed, the programs are so managed that programs D, B and E, and C are positioned in the highest hierarchy (1), the second highest hierarchy (2), and the third highest hierarchy (3), respectively.

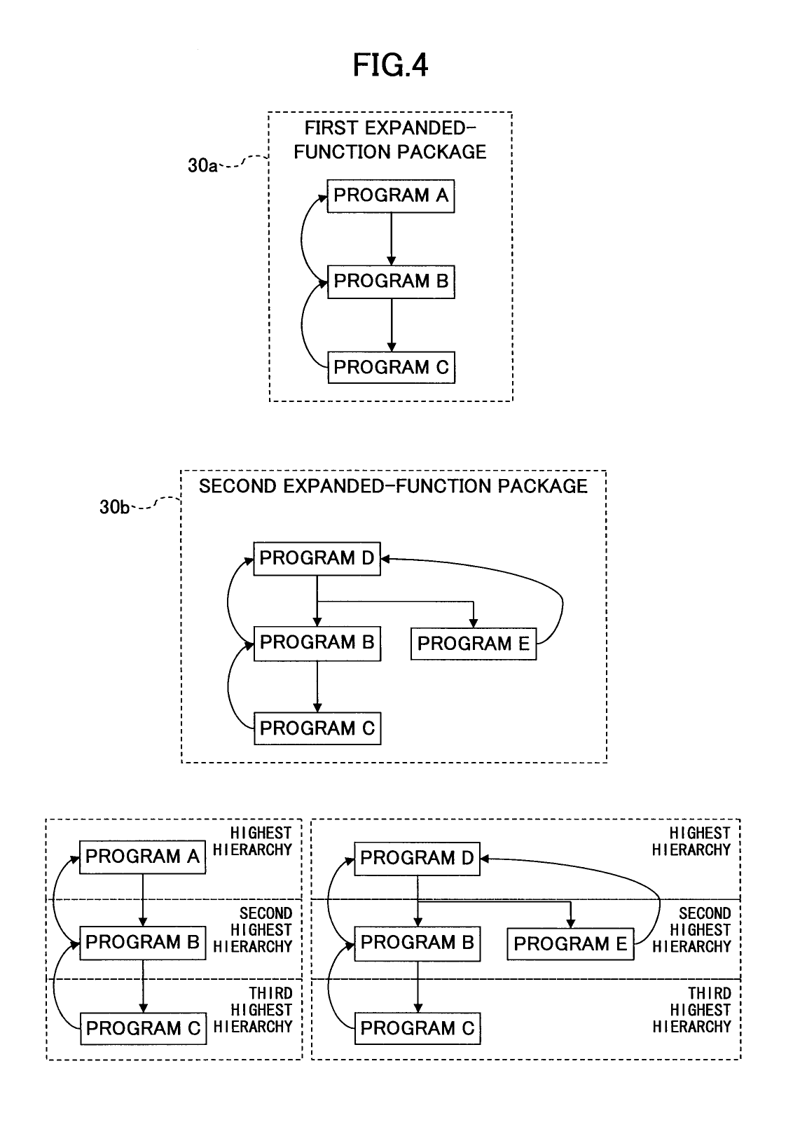

Referring next to FIG. 4, a description is made below about how the programs operate in the image processing apparatus 10 based on the stratified dependence.

FIG. 4 are illustrations showing operational examples of the programs 31 of the expanded functions 42 according to the first embodiment of the present invention.

Programs developed based on the expanded-functions framework 21 include an operations control function that controls the operations of the programs themselves.

For example, let it be assumed that the programs of the first expanded-function package 30a are started. First, when program A positioned in the highest hierarchy is started, program A starts program B that program A itself uses (that is positioned in the second highest hierarchy) based on the hierarchical structure 50. Next, program B starts program C that program B itself uses (that is positioned in the third highest hierarchy).

Since program C does not have a program that program C itself uses (that starts following program C), it notifies program B positioned in the second highest hierarchy of having completed its starting. Program B receives the notification of start completion from program C and then notifies program A positioned in the highest hierarchy of having completed its starting. Last, program A receives the notification of start completion from program B and then notifies a program administrator of having completed its starting.

With the notification from program A, it is determined that all the programs of the first expanded-function package 30a have completed their starting.

Furthermore, let it be assumed that the programs of the second expanded-function package 30b are started. First, when program D positioned in the highest hierarchy is started, program D starts programs B and E that program D itself uses (that are positioned in the second highest hierarchy) based on the hierarchical structure 50. Next, program B starts program C that program B itself uses (that is positioned in the third highest hierarchy).

Since program C does not have a program that program C itself uses (that starts following program C), it notifies program B positioned in the second highest hierarchy of having completed its starting. Program B receives the notification of start completion from program C and then notifies program D positioned in the highest hierarchy of having completed its starting.

Furthermore, since program E also does not have a program that program E itself uses (that starts following program E) like program C, it notifies program D positioned in the highest hierarchy of having completed its starting. Last, program D receives the notifications of start completion from programs B and E and then notifies a program administrator of having completed its starting.

With this notification from program D, it is determined that all the programs of the second expanded-function package 30b have completed their starting.

The operations control function controls the operations of the programs 31 of the expanded functions 42 in such a manner that the programs, which are positioned in the respective hierarchies (hierarchies (1), (2), and (3)) in the hierarchical structure 50 where the dependence (using side or used side) between the programs is stratified, operate in accordance with starting or termination requests from the program positioned in the upper hierarchy based on the information of the hierarchical structure 50.

As shown in FIG. 4, in the case of the first expanded-function package 30a for example, when program A positioned in the highest hierarchy (1) is started, program B positioned in the second highest hierarchy (2) is caused to start with the starting operation of program A being taken over, and then program C positioned in the third highest hierarchy (3) is caused to start with the starting operations of programs A and B being taken over (superseded).

Furthermore, in the case of the second expanded-function package 30b, when program D positioned in the highest hierarchy (1) is started, programs B and E positioned in the second highest hierarchy (2) are caused to start with the starting operation of program D being taken over, and then program C positioned in the third highest hierarchy (3) is caused to start with the starting operations of programs D, B, and E being taken over.

As described above, the programs 31 of the expanded functions 42 can control the operations of the plural programs having the dependence based on the information of the hierarchical structure 50.

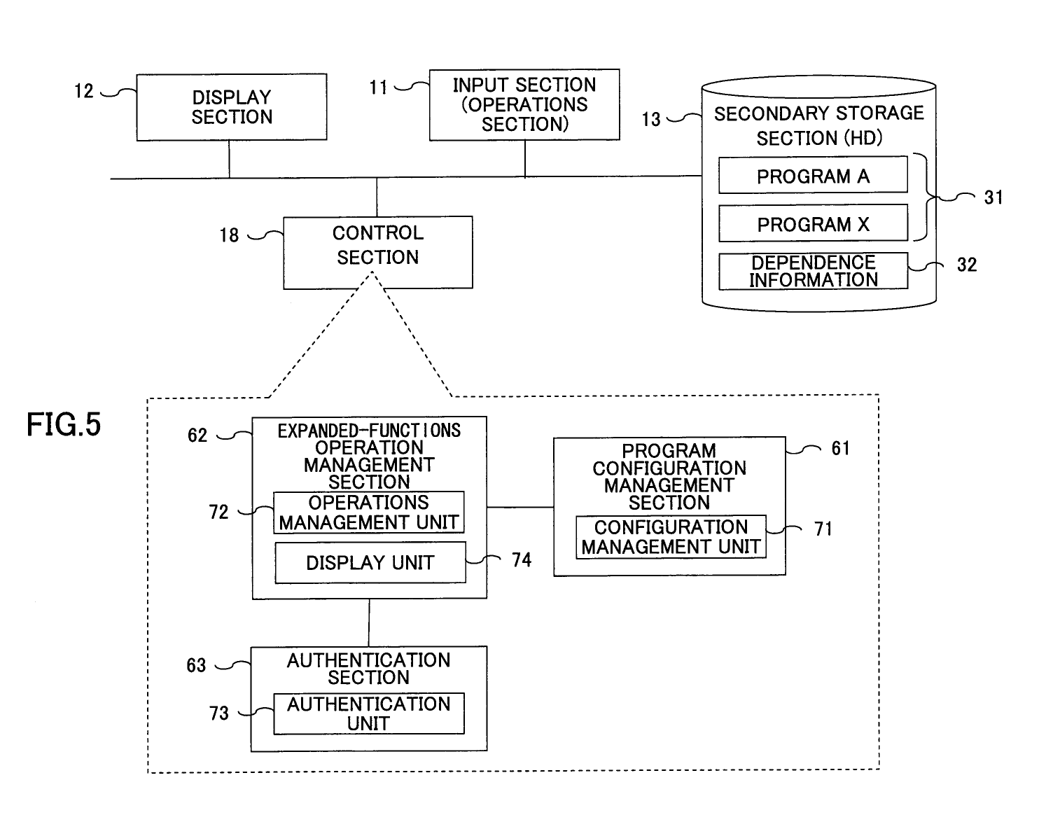

Referring next to FIG. 5, a description is made below about which function sections manage the programs of the expanded functions 42 as described in FIGS. 3 and 4.

FIG. 5 is a block diagram showing a configuration example of a main function section according to the first embodiment of the present invention.

The main function section as shown in FIG. 5 is composed of a program configuration management section 61, an expanded-functions operation management section 62, and an authentication section 63.

The program configuration management section 61 includes a configuration management unit 71 for stratifying the dependence between the programs 31 of the expanded functions 42 and for managing the information of the program configuration and the hierarchical structure 50 for each hierarchy.

The expanded-functions operation management section 62 includes an operations management unit 72 for performing one of the starting, termination, installation, and uninstallation of the programs 31 of the expanded functions 42 and for managing the operations of the programs 31 of the installed expanded functions 42.

Furthermore, the expanded-functions operation management section 62 includes a display unit 74 for displaying the information of the hierarchical structure 50 of the programs 31 of the installed expanded functions 42 on the display screen of the display section 12 of the image processing apparatus 10.

The authentication section 63 includes an authentication unit 73 for authenticating whether the user is authorized to view (refer to) the information of the hierarchical structure 50 on the programs 31 of the installed expanded functions 42.

As described above, the image processing apparatus 10 manages the programs 31 of the expanded functions 42 through the main function section.

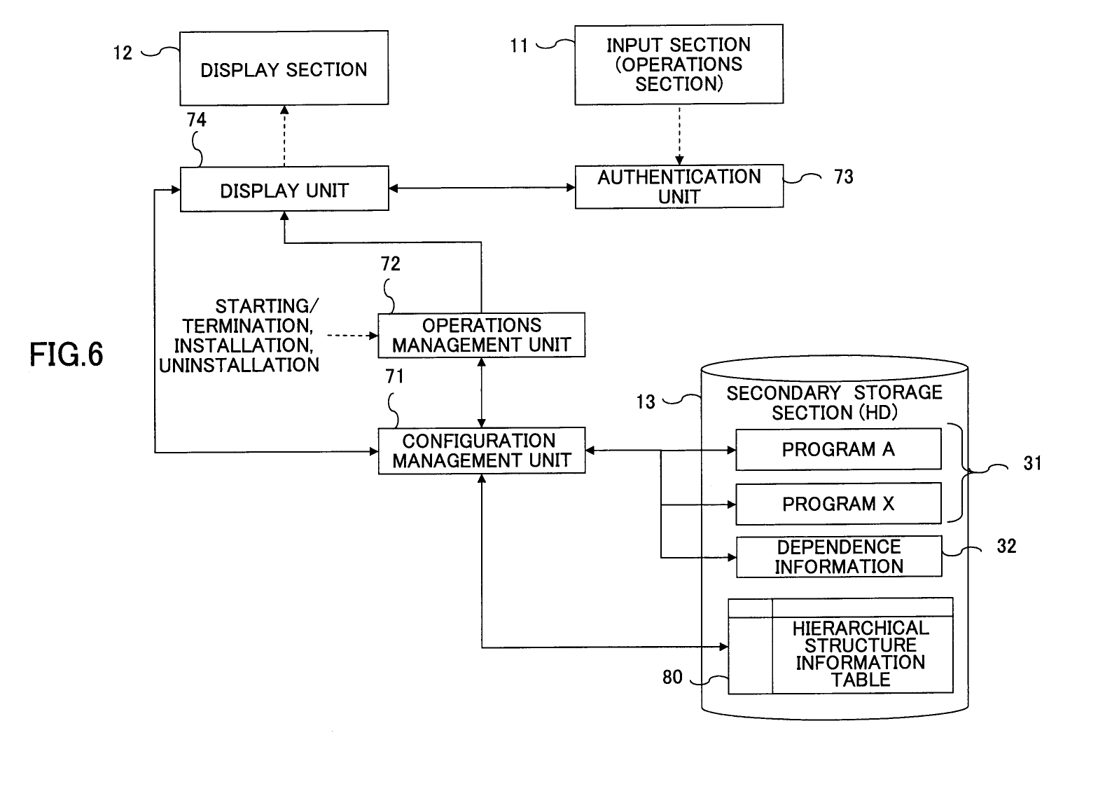

Referring next to FIG. 6, a description is made below of the units of the respective function sections as described in FIG. 5.

FIG. 6 is a block diagram showing a configuration example of the units of the main function section according to the first embodiment of the present invention.

The units of the main function section as shown in FIG. 6 are composed of the configuration management unit 71, the operations management unit 72, the authentication unit 73, and the display unit 74.

First, the configuration management unit 71 of the program configuration management section 61 performs the installation or uninstallation of the expanded-function package 30 in the image processing apparatus 10 in accordance with the installation or uninstallation request.

Furthermore, the configuration management unit 71 stratifies the dependence between the programs 31 of the expanded functions 42 based on dependence information 32 when performing installation. The stratified results (information of the hierarchical structure 50) are formed into a table and held in the secondary storage section 13 as a hierarchical structure information table 80 because they are required for managing the operations of the programs.

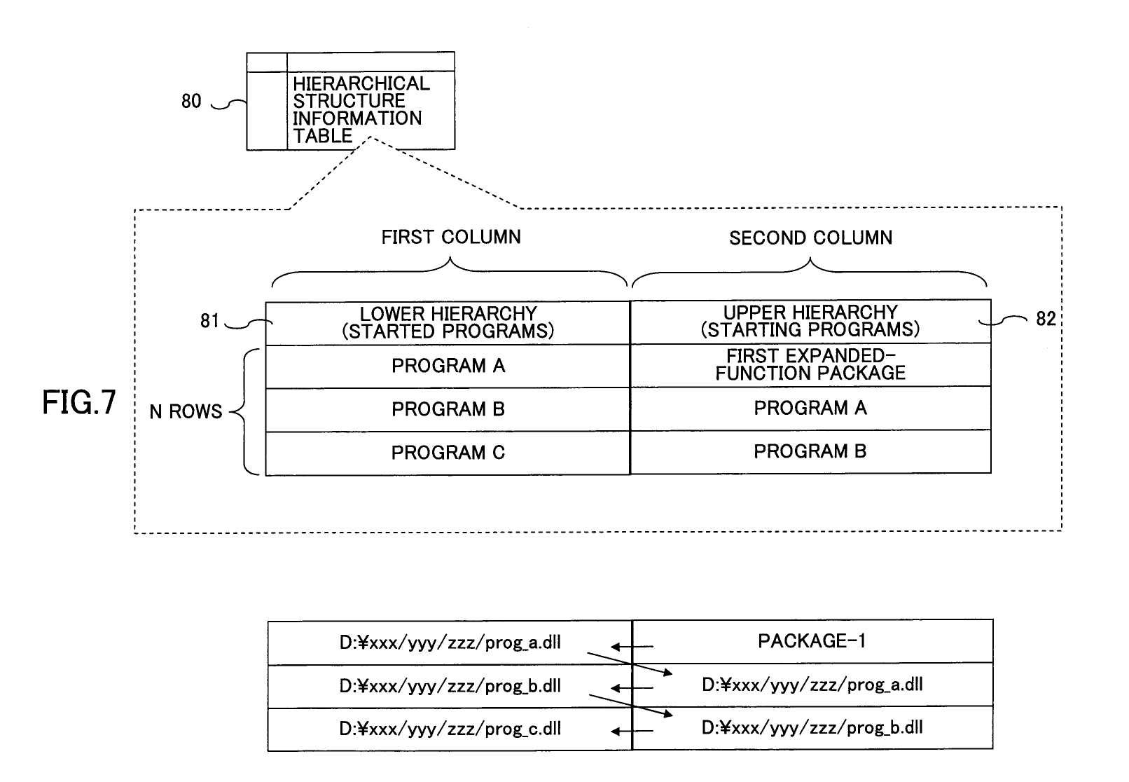

Referring next to an illustration showing a data configuration example of the hierarchical structure information table 80 as shown in FIG. 7, a description is made below of a method by which the configuration management unit 71 stores the information of the hierarchical structure 50 in the hierarchical structure information table 80.

The hierarchical structure information table 80 has a matrix of two columns and N rows: information 81 of started programs (lower hierarchy) and information 82 of starting programs (upper hierarchy) are stored in the first and second columns, respectively.

When the first expanded-function package 30a is installed, for example, the configuration management unit 71 stores, in the item of the second column and the first row, the package name “first expanded-function package (Package-1)” as data for identifying expanded functions, and stores, in the item of the first column and the first row, “information of program A” to be first started when the first expanded-function package 30a starts.

Next, the information of the starting program A is stored in the item of the second row and the second column, and “information of program B” to be started by the program A is stored in the item of the first column and the second row.

Last, the information of the starting program B is stored in the item of the second column and the third row, and “information of program C” to be started by the program B is stored in the item of the first column and the third row.

As shown in FIG. 7, the information 81 and 82 of the programs stored in the hierarchical structure information table 80 are information (for example, “the path names of program data”) indicating storage locations in accordance with the directory structure in the secondary storage section 13 where the programs are stored at the installation.

If the drive name of the secondary storage section 13 is “D-drive,” for example, the information of the program A is “D:¥xxx/yyy/zzz/prog_a.dll.”

As described above, the configuration management unit 71 stores the information 81 and 82 of the programs (the information of storage locations) in the respective items of the hierarchical structure information table 80 at the installation, thereby stratifying the dependence (the information of the hierarchical structure 50) of the programs 31 of the expanded functions 42 as shown by arrows in FIG. 7.

In the case of the first expanded-function package 30a, for example, the dependence (the information of the hierarchical structure 50) between “Package-1→D:¥xxx/yyy/zzz/prog_a.dll,” “prog_a.dll→D:¥xxx/yyy/zzz/prog_b.dll,” and “prog_b.dll→D:¥xxx/yyy/zzz/prog_c.dll” is stratified.

Accordingly, through the configuration management unit 71, the program configuration management section 61 stores the programs of the expanded-function package 30 in the secondary storage section 13 at the installation and at the same time holds the stratified results of the dependence between the programs 31 of the expanded functions 42 based on the dependence information 32, thereby making it possible to manage the programs 31 of the expanded functions 42 for each hierarchy.

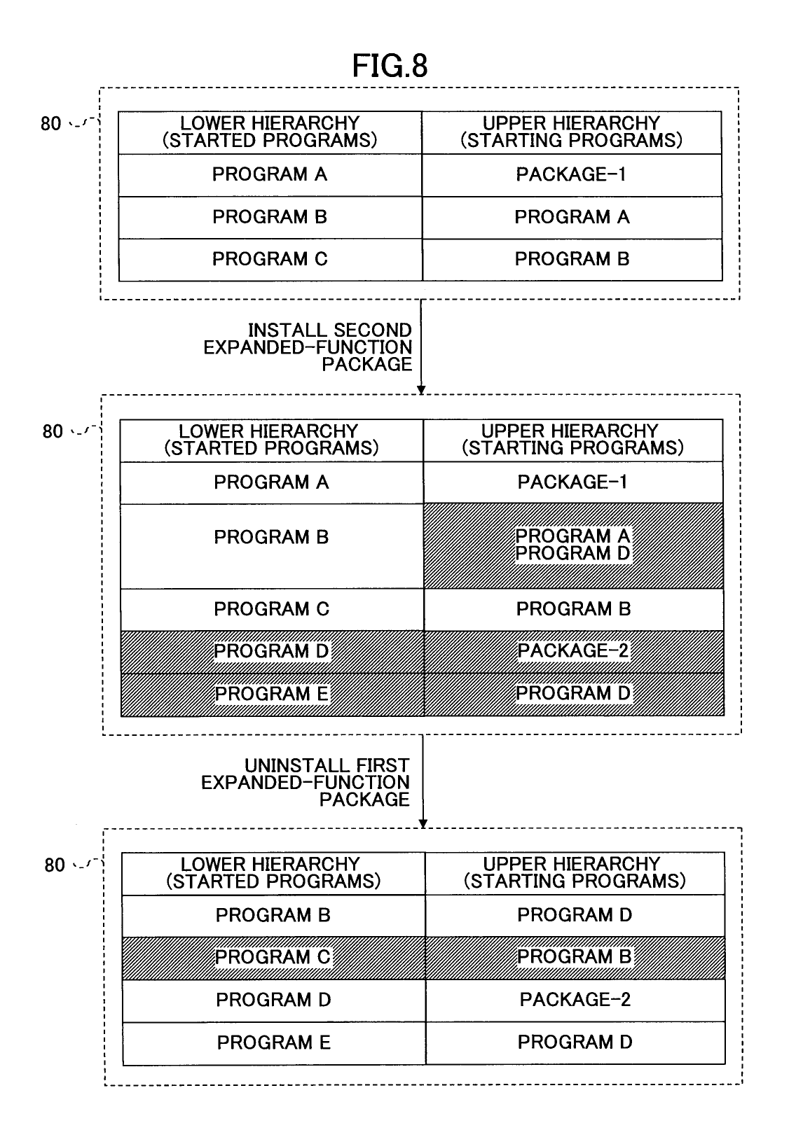

Referring next to FIG. 8 showing an example of updating contents of the hierarchical structure information table 80, a description is made below of the update of the hierarchical structure information table 80 that the configuration management unit 71 performs at the installation or uninstallation.

When the second expanded-function package 30b is installed in the image processing apparatus 10 where the first expanded-function package 30a has been installed, for example, the configuration management unit 71 stratifies the dependence between the programs 31 of the expanded functions 42 based on the dependence information 32 and adds the information 81 and 82 of the programs of the shaded regions in the hierarchical structure information table 80 as shown in the middle part of FIG. 8.

At this time, since programs B and C of the second expanded-function package 30b are the programs contained in the first expanded-function package 30a that has been installed, program D is added to the item of the second row and the second column and the program information 81 indicating the dependence where program D starts program B is added.

Furthermore, when the installed first expanded-function package 30a is uninstalled, the information 81 and 82 of the programs on the first expanded-function package 30a are deleted from the hierarchical structure information table 80 that has been updated at the installation.

At this time, since programs B and C of the first expanded-function package 30a are the programs to be started by program D contained in the second expanded-function package 30b to be subsequently installed, they are not deleted (the shaded regions of the hierarchical structure information table 80 as shown in the lower part of FIG. 8).

Accordingly, through the configuration management unit 71, the program configuration management section 61 performs the adding or deleting of the programs of the expanded-function package 30 as well as of the information 81 and 82 of the programs of the hierarchical structure information table 80 at the installation or uninstallation, thereby making it possible to manage the program configuration of the expanded functions 42 and the information of the hierarchical structure 50.

Furthermore, when instructed to acquire the information of the hierarchical structure 50 managed in the hierarchical structure information table 80, the configuration management unit 71 replies with the information of the hierarchical structure 50 as required.

Accordingly, when instructed to acquire the information of the hierarchical structure 50 by the other function sections, the program configuration management section 61 can replay the information of the hierarchical structure 50 as required through the configuration management unit 71.

Next, when instructed to start the expanded functions 42, the operations management unit 72 of the expanded-functions operation management section 62 starts the program positioned in the highest hierarchy of the expanded functions 42 to be started based on the information of the hierarchical structure 50 of the hierarchical structure information table 80.

Therefore, when instructed to start the expanded functions 42, the operations management unit 72 requests the configuration management unit 71 of the program configuration management section 61 to acquire the information of the hierarchical structure 50 managed in the hierarchical structure information table 80 and then acquires the information of the hierarchical structure 50 to be received from the configuration management unit 71.

Referring next to the data configuration example as shown in the lower part of FIG. 7, a description is made below of starting the expanded-function package 30 by the operations management unit 72.

When instructed to start the first expanded-function package 30a, for example, the operations management unit 72 retrieves all the information of the items in the second row on the package name “Package-1” from the information of the hierarchical structure 50 acquired from the configuration management unit 71.

Then, the operations management unit 72 starts program A in accordance with the information “D:¥xxx/yyy/zzz/prog._a.dll” in the first column and the first row, which has the dependence with the corresponding package name “Package-1.”

As described above, the operations management unit 72 starts the program positioned in the highest hierarchy of the first expanded-function package 30a.

Furthermore, based on the notification of start completion from the respective programs to be transmitted from the lower hierarchy to the upper hierarchy by the operations control function of the programs, the operations management unit 72 determines whether the starting expanded functions 42 have normally started by receiving the notification of start completion from the program positioned in the highest hierarchy.

As for the termination of the programs, the operations management unit 72 issues a termination request to the program positioned in the highest hierarchy of the expanded functions 42 to be terminated in the same manner as starting.

Accordingly, through the operations management unit 72, the expanded-functions operation management section 62 performs the starting or terminating of the programs based on the information of the hierarchical structure 50 acquired from the configuration management unit 71, thereby making it possible to manage the operations of the programs 31 of the installed expanded functions 42.

As described above, the configuration management section 71 manages the information on the expanded functions 42 with the hierarchical structure information table 80, and the operations management unit 72 manages the operations of starting and terminating the programs 31 of the expanded functions 42 based on the hierarchical structure information table 80. Thereby, it is not necessary to change the program code of the program management section unlike conventional methods. Furthermore, it is possible to easily manage expanded functions due to the low dependence between the programs 31 of the expanded functions 42 and the program management section.

Furthermore, since a method of managing the programs of the expanded functions 42 is simplified, it is possible to reduce processing work loads to manage programs when plural functions are expanded.

Accordingly, the image processing apparatus 10 can achieve a system excellent in function expandability, function introduction flexibility, and product performance quality.

Furthermore, when instructed to show (refer to) the information of the hierarchical structure 50 on the programs 31 of the installed expanded functions 42, the display unit 74 of the expanded-functions operation management section 62 displays the information of the hierarchical structure 50 on the display screen of the display section 12 based on the information of the hierarchical structure 50 of the hierarchical structure information table 80.

Therefore, when instructed to show (refer to) the information of the hierarchical structure 50 on the programs 31 of the expanded functions 42, the display unit 74 requests the configuration management unit 71 of the program configuration management section 61 to acquire the information of the hierarchical structure 50 managed in the hierarchical structure information table 80, and then acquires the information of the hierarchical structure 50 to be received from the configuration management unit 71.

Furthermore, the display unit 74 restricts the range of information of the hierarchical structure 50 to be displayed, based on reference authority (viewing authority) managed in the authentication section 63.

Therefore, the display unit 74 requests the authentication unit 73 of the authentication section 63 as is described below to authenticate the user who wishes to view (refer to) the information, and then acquires the information of the reference authority (viewing authority) of the user received from the authentication unit 73 as an authentication result.

Accordingly, through the display unit 74, the expanded-functions operation management section 62 can display the information of the hierarchical structure 50 on the programs 31 of the installed expanded functions 42 on the display screen of the display section 12 based on the information of the hierarchical structure 50 acquired from the configuration management unit 71.

Furthermore, the display unit 74 can restrict the range of information of the hierarchical structure 50 to be displayed, based on the information of the reference authority (viewing authority) of the user received from the authentication unit 73 as the authentication result.

Next, when requested for the authentication of the user, the authentication unit 73 of the authentication section 63 authenticates whether the user is authorized to view (refer to) the information of the hierarchical structure 50 on the programs 31 of the installed expanded functions Therefore, when requested for the authentication by the display unit 74 of the expanded-functions operation management section 62, the authentication unit 73 authenticates whether the user is authorized to view (refer to) the information of the hierarchical structure 50 on the programs 31 of the installed expanded functions 42 based on identification information (for example, “a user ID”) and a password of the user input with the input section 11.

Furthermore, with respect to users who are authenticated and registered, the authentication unit 73 manages the reference authority (viewing authority) that restricts the range of information of the hierarchical structure 50 to be displayed for each user and uses the reference authority (viewing authority) of the corresponding user as an authentication result.

Accordingly, through the authentication unit 73, the authentication section 63 can authenticate whether the user is authorized to view (refer to) the information of the hierarchical structure 50 on the programs 31 of the installed expanded functions 42.

As described above, the image processing apparatus 10 manages the programs 31 of the expanded functions 42 through the respective units of the main function section.

Accordingly, the image processing apparatus 10 manages the programs having the operations control function with the hierarchical structure 50. Thereby, it is not necessary to perform centralized management of all the programs at one management section unlike conventional methods. Furthermore, it is possible to facilitate the program management of the expanded functions 42 due to the low dependence between the programs 31 of the expanded functions 42 and the program management section, thereby achieving a system excellent in expandability.

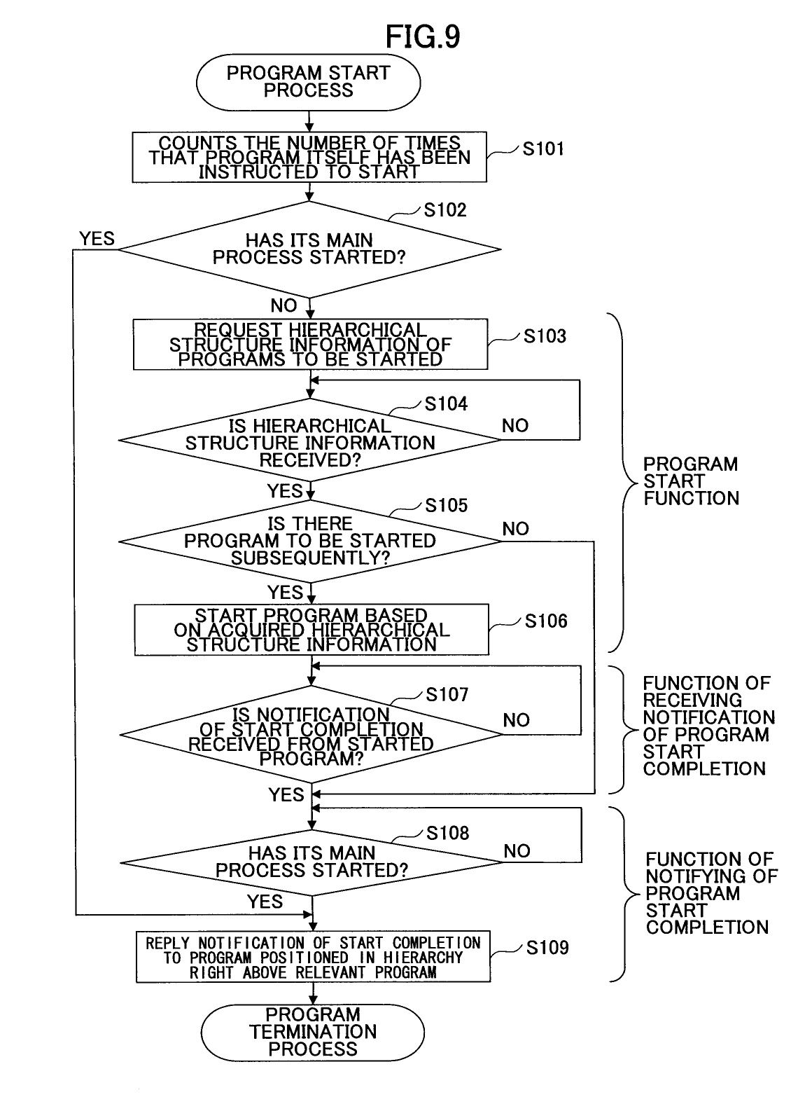

Referring next to FIGS. 9 through 20, a description is made below of a detailed method of achieving the program management of the expanded functions 42.

Furthermore, all the program management methods of the expanded functions 42 as are described below are to be achieved by programs and implemented by the control section 18 of the image processing apparatus 10 as shown in FIG. 5.

Accordingly, computer-readable recording media may store the programs constituting the present invention.

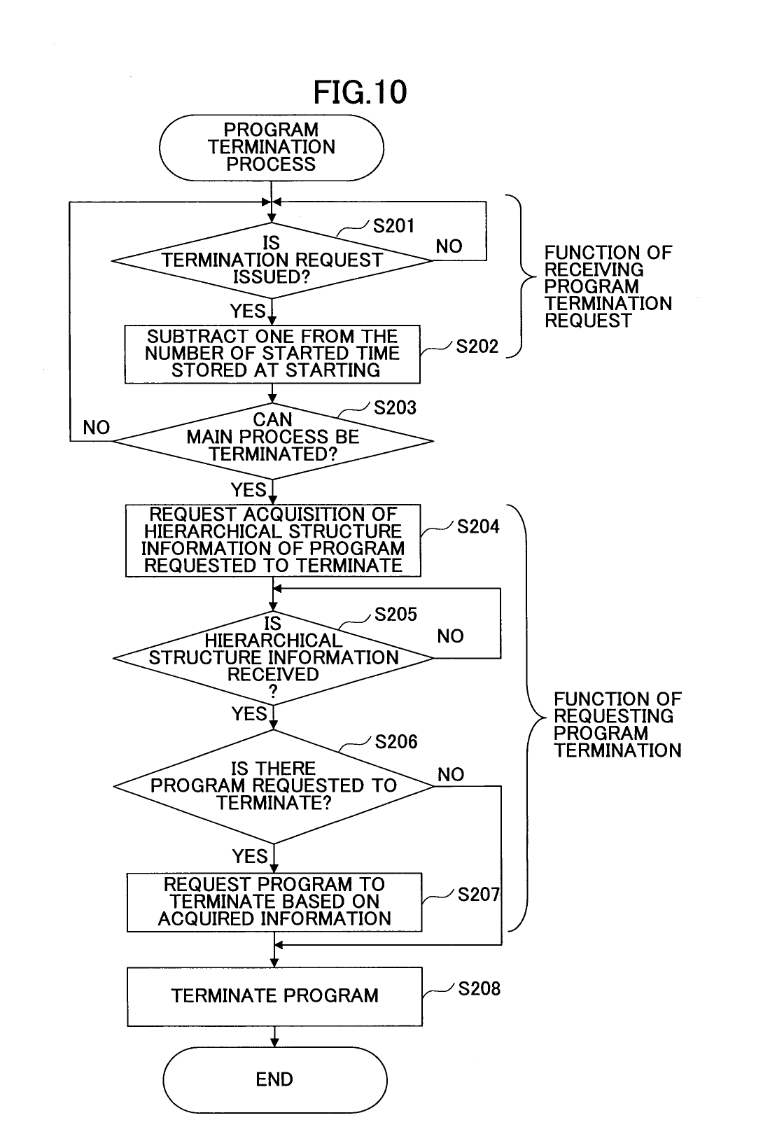

Referring to FIGS. 9 and 10, a description is first specifically made below of the process of the operations control function of the programs 31 of the expanded functions 42 as shown in FIG. 4.

When instructed to start or terminate the expanded functions 42, the expanded-functions operation management section 62 starts or terminates the program positioned in the highest hierarchy among the programs 31 of the expanded functions 42 through the operations management unit 72.

Consequently, with the operation of starting or terminating of the expanded functions 42 being taken over for each hierarchy in accordance with the chain-reaction dependence (the information of the hierarchical structure 50) between the programs, all the programs of the expanded-function package 30 are caused to start or terminate.

Accordingly, the operations control function of the programs 31 of the expanded functions 42 refers to the function of achieving the chain-reaction starting or terminating operations between the programs.

The operations control function of the programs 31 of the expanded functions 42 includes “a program start function,” “a function of receiving notification of program start completion,” and “a function of reporting program start completion” as a program start function and “a function of receiving a program termination request” and “a function of requesting program termination” as a program terminating function.

FIG. 9 is a flowchart showing a process regarding the program start function of the programs 31 of the expanded functions 42 according to the first embodiment of the present invention.

The program start function counts the number of (started) times that the program has been instructed to start and holds the counted value (default is zero) in the RAM (S101).

Next, the program start function determines whether a main process has started based on the held counted value (S102).

If the counted value is two or more and the main process has started (YES in S102), the program start function sends the notification of start completion to the program positioned in the hierarchy right above the relevant program based on the information of the hierarchical structure 50 acquired at the starting (S109).

If the counted value is one and the main process has never started (NO in S102), the program start function requests the configuration management unit 71 of the program configuration management section 61 to acquire the information of the hierarchical structure 50 managed in the hierarchical structure information table 80 (S103), and is on standby for the information of the hierarchical structure 50 to be received from the configuration management unit 71 (S104).

If the information of the hierarchical structure 50 is received from the configuration management unit 71 (YES in S104), the program start function determines whether there exists a program to be started subsequently based on the acquired information of the hierarchical structure 50 (S105).

If there exists a program to be started subsequently (YES in S105), the program start function starts the program positioned in the hierarchy right below the relevant program based on the information of the program to be started (program data path) and is on standby for the notification of start completion from the started program (S107).

If the notification of start completion is received from the started program (YES in S107) or if there does not exist a program to be started subsequently (NO in S105), the program start function determines that the relevant program is the program positioned in the lowest hierarchy, is on standby for the start completion of its main process (S108), and thereafter (YES in S108) transmits the notification of its start completion to the program positioned in the hierarchy right above the relevant program based on the information of the hierarchical structure 50 (S109).

As described above, in consideration of programs commonly contained in the different expanded functions 42 besides “the program start function (S103 through S106),” “the function of receiving notification of program start completion (S107),” and “the function of notifying of program start completion (S108 and S109),” the program start function is so designed as to determine that its main process has started (determine that the programs positioned in the lower hierarchies have also started if its own program has started) and transmit only the notification of start completion when instructed to start.

FIG. 10 is a flowchart showing a process regarding the program terminating function of the programs 31 of the expanded functions 42 according to the first embodiment of the present invention.

The program terminating function is on standby for a termination request from the program positioned in the hierarchy right above the relevant program (S201). If the program terminating function receives the termination request (YES in S201), it subtracts one from the value (counted value) indicating the number of (counted) times counted at the starting and held in RAM.

Next, the program terminating function determines whether the main process in operation can be terminated based on the subtracted value (S203).

If the subtracted value is one or more and the main process cannot be terminated (NO in S203), the program terminating function returns to be on standby for the termination request from the program positioned in the hierarchy right above the relevant program (returns to S201).

If the subtracted value is one and the main process can be terminated (YES in S203), the program terminating function requests the configuration management unit 71 of the program configuration management section 61 to acquire the information of the hierarchical structure 50 managed in the hierarchical structure information table 80 (S204) and is on standby for the information of the hierarchical structure 50 to be received from the configuration management unit 71 (S205).

If the information of the hierarchical structure 50 is received from the configuration management unit 71 (YES in S205), the program terminating function determines whether there exists a program requested to terminate subsequently on the acquired information of the hierarchical structure 50 (S206).

If there exists a program requested to terminate subsequently (YES in S206), the program terminating function issues a termination request to the program positioned in the hierarchy right below the relevant program based on the information of the program to be terminated (program data path) and terminates its main process (S208).

If there does not exist a program requested to terminate subsequently (NO in S206), the function terminating function determines that the relevant program is the program positioned in the lowest hierarchy and terminates its main process (S208).

As described above, in consideration of programs commonly contained in the different expanded functions 42 besides “the function of receiving a program termination request (S201)” and “the function of requesting program termination (S204 through S207),” the program terminating function is so designed as to determine that its main process can be terminated (determines that the other expanded functions 42 have not used the main process) when receiving the termination request and terminates the main process.

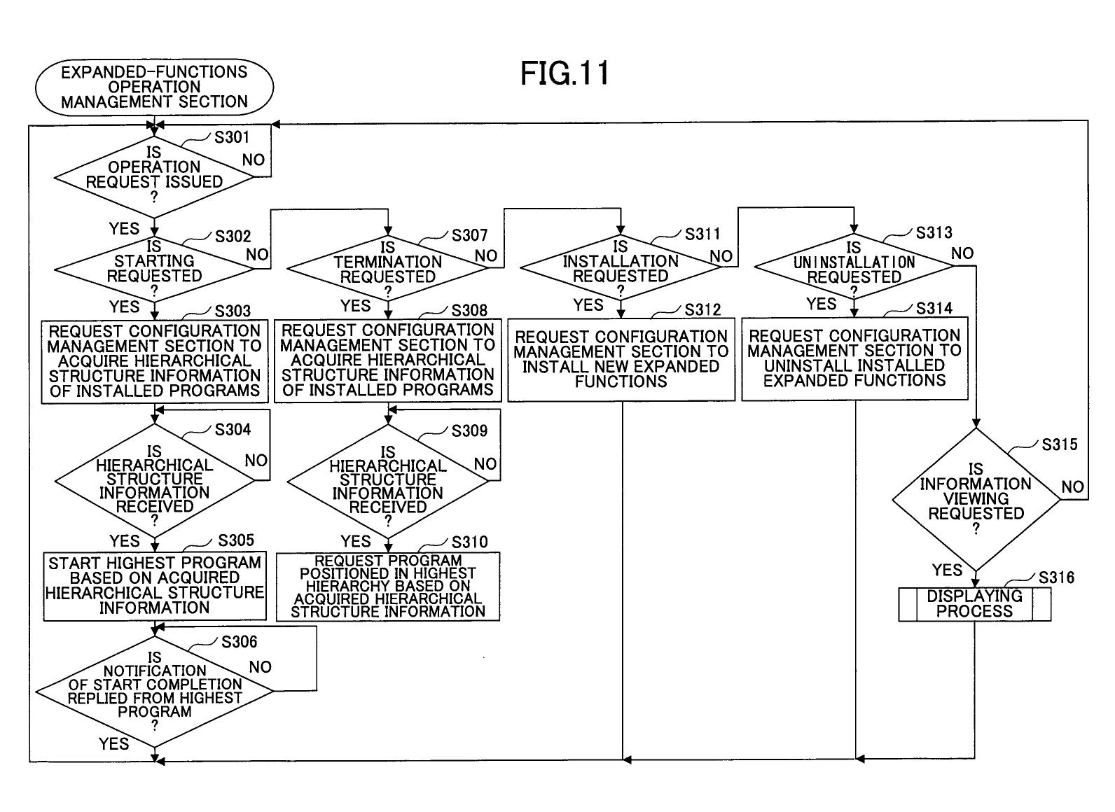

Referring next to FIGS. 11 through 14, a description is specifically made of the process of the main function section of the image processing apparatus 10 as shown in FIGS. 5 and 6.

FIG. 11 is a flowchart showing a process regarding the expanded-functions operation management section 62 according to the first embodiment of the present invention.

The operations management unit 72 of the expanded-functions operation management section 62 is on standby for an operation request from the system of the image processing apparatus 10 (S301). At this time, the types of operation request are “starting,” “termination,” “installation,” “uninstallation,” or “information viewing (information reference).”

For example, “starting” is requested when the power of the image processing apparatus 10 is turned on, and “termination” is requested before the system of the image processing apparatus 10 is terminated or uninstalled.

“Installation or uninstallation” is requested on an irregular base, for example, when instructed by the administrator of the image processing apparatus 10 through the input section 11 or instructed by the management server.

In the same manner as “installation or uninstallation,” “information viewing (information reference)” is requested on an irregular base, for example, when instructed by the administrator of the image processing apparatus 10 through the input section 11 or instructed by the management server.

When receiving the operation request (YES in S301), the operations management unit 72 determines which one of the requests “starting,” “termination,” “installation,” “uninstallation,” and “information viewing (information reference)” the requested operation is (S302, S307, S311, S313, and S315).

If the operation of “starting” is requested (YES in S302), the operations management unit 72 requests the configuration management unit 71 of the program configuration management section 61 to acquire the information of the hierarchical structure 50 managed in the hierarchical structure information table 80 (S303) and is on standby for the information of the hierarchical structure 50 to be received from the configuration management unit 71 (S304).

If the information of the hierarchical structure 50 is received from the configuration management unit 71 (YES in S304), the operations management unit 72 starts the program positioned in the highest hierarchy of the expanded functions 42 to be started based on the acquired information (program data path) of the hierarchical structure 50 (S305) and is on standby for the notification of start completion received from the started program (S306).

When receiving the notification of start completion from the started program (YES in S306), the operations management unit 72 determines that the started expanded functions 42 have completed their starting and thereafter returns to be on standby for the operation request from the system of the image processing apparatus 10 (returns to S301).

If the operation of “termination” is requested (NO in S302 and YES in S307), the operations management unit 72 requests the configuration management unit 71 of the program configuration management section 61 to acquire the information of the hierarchical structure 50 managed in the hierarchical structure information table 80 (S308) and is on standby for the information of the hierarchical structure 50 to be received from the configuration management unit 71 (S309).

If the information of the hierarchical structure 50 is received from the configuration management unit 71 (YES in S309), the operations management unit 72 issues the termination request to the program positioned in the highest hierarchy of the expanded functions 42 to be terminated based on the acquired information (program data path) of the hierarchical structure 50 (S310) and thereafter returns to be on standby for the operation request from the system of the image processing apparatus 10 (returns to S301).

If the operation of “installation” is requested (NO in S307 and YES in S311), the operations management unit 72 requests the configuration management unit 71 of the program configuration management section 61 to install new expanded functions 42 (S312) and thereafter returns to be on standby for the operation request from the system of the image processing apparatus 10 (returns to S301).

If the operation of “uninstallation” is requested (NO in S311 and YES in S313), the operations management unit 72 requests the configuration management unit 71 of the program configuration management section 61 to uninstall the designated function among the installed expanded functions 42 (S314).

Then, the operations management unit 72 returns to be on standby for the operation request from the system of the image processing apparatus 10 (returns to S301).

If the operation of “information viewing (information reference)” is requested (NO in S313 and YES in S315), the operations management unit 72 performs a displaying process through the display unit 74 (S316) and thereafter returns to be on standby for the operation request from the system of the image processing apparatus 10 (returns to S301).

If the requested operation does not represent (is not) one of the “starting request,” “termination request,” “installation request,” “uninstallation request,” and “information viewing request (information reference request)” (NO in S315), the operations management unit 72 returns to be on standby for the operation request from the system of the image processing apparatus 10 (returns to S301).

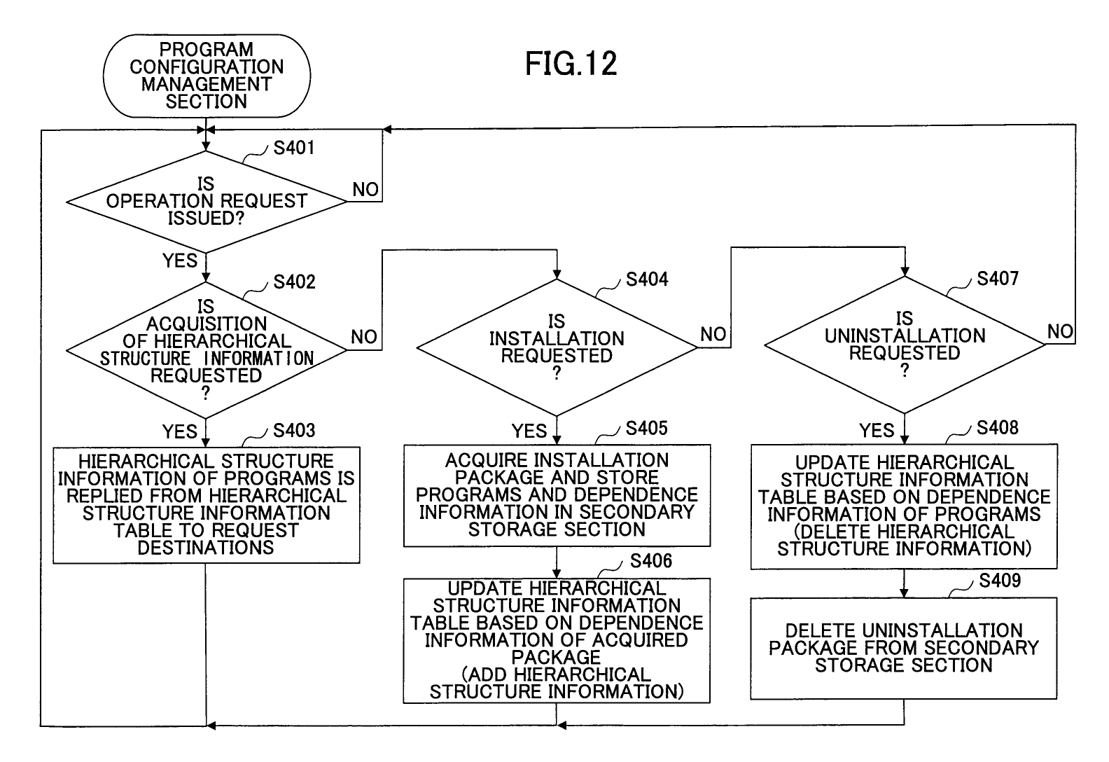

FIG. 12 is a flowchart showing a process regarding the program configuration management section 61 according to the first embodiment of the present invention.

The configuration management unit 71 of the program configuration management section 61 is on standby for the request from the respective programs of the expanded-functions operation management section 62 (operations management unit 72 and display unit 74) or the expanded functions 42 (S401). The requested contents represent “acquisition of the information of the hierarchical structure 50,” “installation,” or “uninstallation.”

“Acquisition of the information of the hierarchical structure 50” is requested by the respective programs of the expanded-functions operation management section 62 and the expanded functions 42.

“Installation or uninstallation” is requested by the expanded-functions operation management section 62.

When receiving the operation request (YES in S401), the configuration management unit 71 determines which one of the requests “acquisition of the information of the hierarchical structure 50,” “installation,” and “uninstallation” the requested content represents (S402, S404, and S407).

If the content of “acquisition of the information of the hierarchical structure 50” is requested (YES in S402), the configuration management unit 71 sends the information of the hierarchical structure 50 managed in the hierarchical structure information table 80 to acquisition request destinations (the respective programs of the expanded-functions operation management section 62 or the expanded functions 42) (S403) and thereafter returns to be on standby for the requests from the respective programs of the expanded-functions operation management section 62 or the expanded functions 42 (returns to S401).

If the content of “installation” is requested (NO in S402 and YES S404), the configuration management unit 71 acquires the expanded-function package 30 for installation from the management server, memory cards, recording media or the like and stores the programs 31 and the dependence information 32 constituting the package in the secondary storage section 13 (S405). At this time, the configuration management unit 71 does not store the programs, which have been stored, based on the information of the hierarchical structure 50 managed in the hierarchical structure information table 80.

Next, the configuration management unit 71 adds the information on the programs 31 of the new expanded functions 42 based on the dependence information 32 and updates the hierarchical structure information table 80 (S406). At this time, the configuration management unit 71 does not update the information on the programs, which have been stored, based on the information of the hierarchical structure 50 managed in the hierarchical structure information table 80.

Then, the configuration management unit 71 returns to be on standby for the requests from the respective programs of the expanded-functions operation management section 62 or the expanded functions 42 (returns to S401).

If the content of “uninstallation” is requested (NO in S404 and YES in S407), the configuration management unit 71 deletes the information on the programs 31 of the expanded functions 42 based on the dependence information 32 and updates the hierarchical structure information table 80 (S408). At this time, the configuration management unit 71 does not delete the information on the programs being used by the other expanded functions 42 among the programs 31 of the expanded functions 42 to be uninstalled, based on the information of the hierarchical structure 50 managed in the hierarchical structure information table 80.

Next, the configuration management unit 71 deletes the programs 31 of the expanded functions 42 from the secondary storage section 13 based on the dependence information 32 and then deletes the dependence information 32 (S409). At this time, the configuration management unit 71 does not delete the programs being used by the other expanded functions 42 among the programs 31 of the expanded functions 42 to be uninstalled, based on the information of the hierarchical structure 50 managed in the hierarchical structure information table 80.

Then, the configuration management unit 71 returns to be on standby for the requests from the respective programs of the expanded-functions operation management section 62 or the expanded functions 42 (returns to S401).

If any one of the contents “acquisition of the information of the hierarchical structure 50,” “installation,” and “uninstallation” is not requested (NO in S407), the configuration management unit 71 returns to be on standby for the requests from the respective programs of the expanded-functions operation management section 62 or the expanded functions 42.

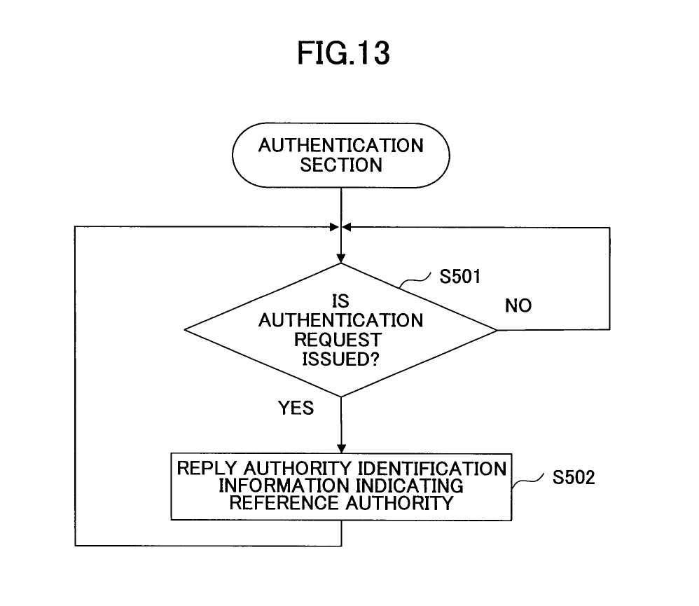

FIG. 13 is a flowchart showing a process regarding the authentication section 63 according to the first embodiment of the present invention.

The authentication unit 73 of the authentication section 63 is on standby for an authentication request for authenticating whether the user is authorized to view (refer to) the information of the hierarchical structure 50 on the programs 31 of the installed expanded functions 42 (S501). At this time, identification information (for example, “a user ID”) and a password of the user input with the input section 11 are received as authentication information of the user.

When requested for the authentication (the authentication information of the user) (YES in S501), the authentication unit 73 determines the user authentication based on the authentication information and supplies authority identification information indicating reference authority (viewing authority) that restricts the available range of information set for each user (S502).

Then, the authentication unit 73 returns to be on standby for the authentication request for authenticating whether the user is authorized to view (refer to) the information of the hierarchical structure 50 (returns to S501).

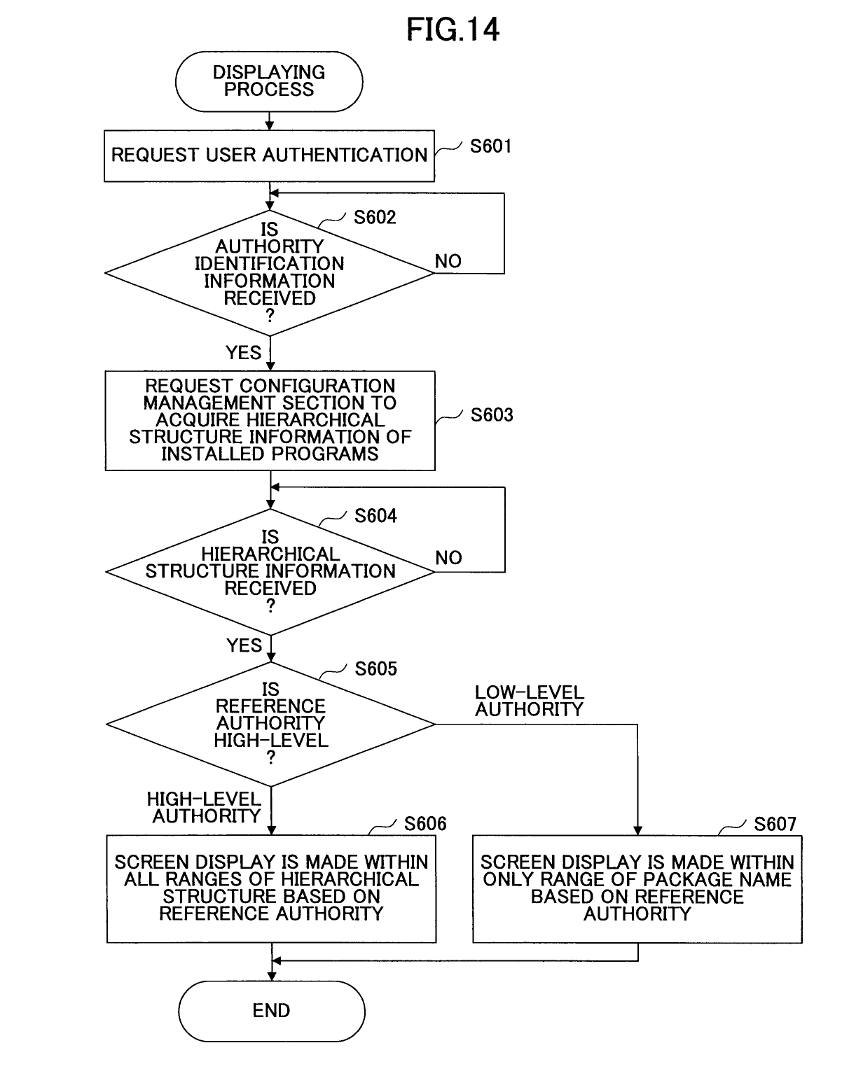

FIG. 14 is a flowchart showing a displaying process according to the first embodiment of the present invention.

The display unit 74 of the expanded-functions operation management section 62 requests the authentication unit 73 of the authentication section 63 to authenticate the user (S601) and is on standby for the authority identification information to be received from the authentication unit 73 (S602).

If the authority identification information is received from the authentication unit 73 (YES in S602), the display unit 74 requests the configuration management unit 71 of the program configuration management section 61 to acquire the information of the hierarchical structure 50 managed in the hierarchical structure information table 80 (S603) and is on standby for the information of the hierarchical structure 50 to be received from the configuration management unit 71 (S604).

If the information of the hierarchical structure 50 is received from the configuration management unit 71 (YES in S604), the display unit 74 determines the available range of the information for the user relative to the acquired information of the hierarchical structure 50 based on the acquired authority identification information (reference authority (viewing authority)).

If the user has high-level reference authority (viewing authority) (“high-level authority” in S605), the display unit 74 transmits the necessary information of the hierarchical structure 50 to the system to display on the display screen all the acquired information of the hierarchical structure 50 (S606).

If the user has low-level reference authority (viewing authority) (“low-level authority” in S605), the display unit 74 transmits the necessary information of the hierarchical structure 50 to the system to display on the display screen only the package name of the expanded functions 42 among the acquired information items of the hierarchical structure 50 (S607).

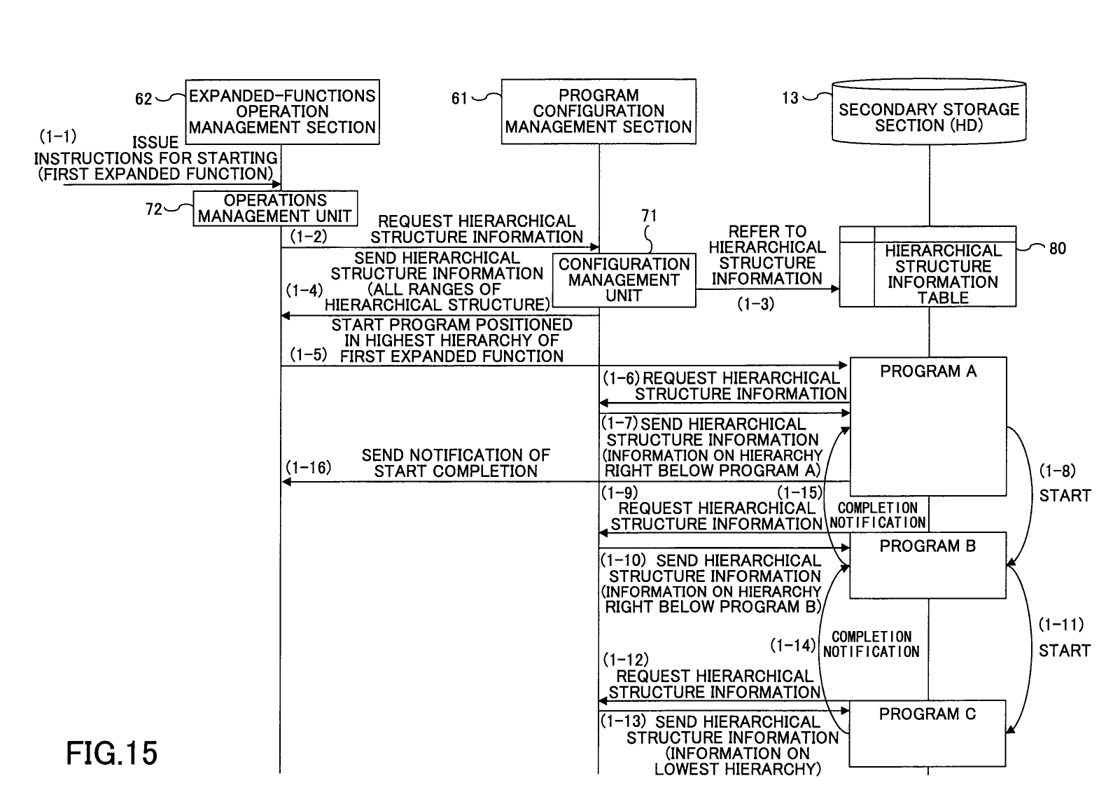

Next, in order to make clear the relationship between the program having the operations control function as shown in FIGS. 9 and 10 and the process of the main function unit as shown in FIGS. 11 through 14, a description is made below of the flow of starting, termination, installation, and uninstallation of the expanded functions 42 of the image processing apparatus 10 referring to FIGS. 15 through 20.

FIG. 15 is a sequence diagram showing the flow of starting the first expanded function according to the first embodiment of the present invention.

First, the system of the image processing apparatus 10 issues instructions for starting the first expanded function to the expanded-functions operation management section 62 (1-1).

Through the operations management unit 72, the expanded-functions operation management section 62 requests the program configuration management section 61 to acquire the information of the hierarchical structure 50 (1-2).

Through the configuration management unit 71, the program configuration management section 61 acquires the information of the hierarchical structure 50 from the hierarchical structure information table 80 stored in the secondary storage section 13 (1-3) and sends the acquired information of the hierarchical structure 50 to the expanded-functions operation management section 62 The expanded-functions operation management section 62 starts program A positioned in the highest hierarchy of the first expanded function based on the received information of the hierarchical structure 50 “Package-1→D:¥xxx/yyy/zzz/prog_a.dll” (1-5).

Program A requests the program configuration management section 61 to acquire the information of the hierarchical structure 50 through the operations control function (1-6), and the program configuration management section 61 sends the information of the hierarchical structure 50 to program A through the configuration management unit 71 (1-7).

Program A starts program B positioned in the hierarchy right below program A based on the received information of the hierarchical structure 50 “prog_a.dll→D:¥xxx/yyy/zzz/prog_b.dll” through the program start function (1-8).

Program B requests the program configuration management section 61 to acquire the information of the hierarchical structure 50 through the operations control function (1-9), and the program configuration management section 61 sends the information of the hierarchical structure 50 to program B through the configuration management unit 71 (1-10).

Program B starts program C positioned in the hierarchy right below program B based on the received information of the hierarchical structure 50 “prog_b.dll→D:¥xxx/yyy/zzz/prog_c.dll” through the program start function (1-11).

Program C requests the program configuration management section 61 to acquire the information of the hierarchical structure 50 through the operations control function (1-12), and the program configuration management section 61 sends the information of the hierarchical structure 50 to program C through the configuration management unit 71 (1-13).

Through the program start function, program C determines that program C itself is the program positioned in the lowest hierarchy based on the received information of the hierarchical structure 50. After its main process has started, program C transmits the notification of start completion to program B positioned in the hierarchy right above program C through the function of reporting program start completion (1-14).

After its main process has started, program B receives the notification of start completion from program C through the function of receiving notification of program start completion. After having confirmed the start completion of program C positioned in the lower hierarchy, program B transmits the notification of start completion to program A positioned in the hierarchy right above program B based on the acquired information of the hierarchical structure 50 through the function of reporting program start completion (1-15).

After its main process has started, program A receives the notification of start completion from program B through the function of receiving notification of program start completion. After having confirmed the start completions of programs B and C positioned in the lower hierarchies, program A transmits the notification of start completion to the operations management unit 72 of the expanded-functions operation management section 62, which had started program A, based on the acquired information of the hierarchical structure 50 through the function of reporting program start completion (1-16).

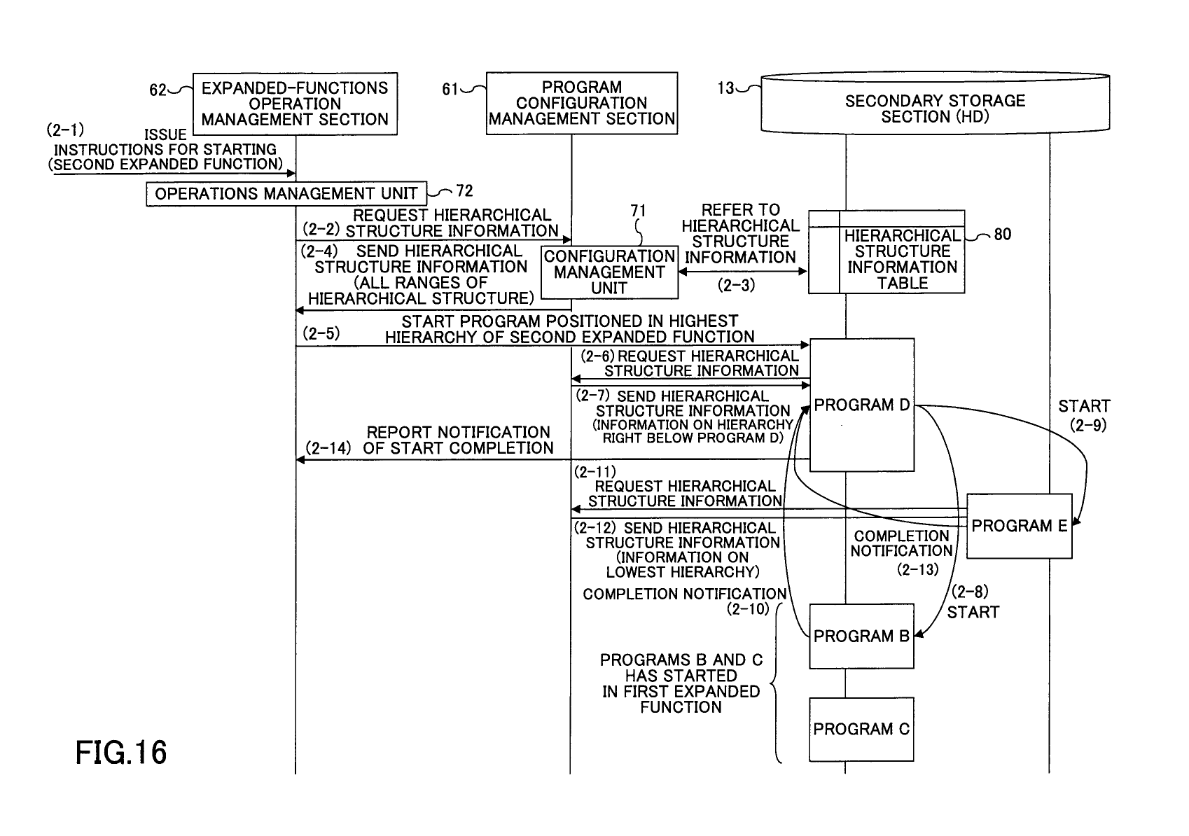

FIG. 16 is a sequence diagram showing the flow of starting the second expanded function according to the first embodiment of the present invention.

First, the system of the image processing apparatus 10 issues instructions for starting the second expanded function to the expanded-functions operation management section 62 (2-1).

Through the operations management unit 72, the expanded-functions operation management section 62 requests the program configuration management section 61 to acquire the information of the hierarchical structure 50 (2-2).

The program configuration management section 61 acquires the information of the hierarchical structure 50 from the hierarchical structure information table 80 stored in the secondary storage section 13 through the configuration management unit 71 (2-3) and sends the acquired information of the hierarchical structure 50 to the expanded-functions operation management section 62 (2-4).

The expanded-functions operation management section 62 starts program D positioned in the highest hierarchy of the second expanded function based on the received information of the hierarchical structure 50 “Package-2→D:¥xxx/yyy/zzz/prog_d.dll” (2-5).

Program D requests the program configuration management section 61 to acquire the information of the hierarchical structure 50 through the operations control function (2-6), and the program configuration management section 61 sends the information of the hierarchical structure 50 to program D through the configuration management unit 71 (2-7).

Program D starts programs B and E positioned in the hierarchy right below program D based on the received information of the hierarchical structure 50 “prog_d.dll→D:¥xxx/yyy/zzz/prog_b.dll and prog_d.dll→D:¥xxx/yyy/zzz/prog_e.dll” through the program start function (2-8 and 2-9).

Program B determines that its main process has been started by the other expanded function 42 (first expanded function) through the operations control function and transmits the notification of start completion to program D positioned in the hierarchy right above program B based on the acquired information of the hierarchical structure 50 through the function of reporting program start completion (2-10).

Program E requests the program configuration management section 61 to acquire the information of the hierarchical structure 50 through the operations control function (2-11), and the program configuration management section 61 sends the information of the hierarchical structure 50 to program E through the configuration management unit 71 (2-12).

Through the program start function, program E determines that program E itself is the program positioned in the lowest hierarchy based on the received information of the hierarchical structure 50. After its main process has started, program E transmits the notification of start completion to program D positioned in the hierarchy right above program E through the function of reporting program start completion (2-13).

After its main process has started, program D receives the notifications of start completion from programs B and E through the function of receiving notification of program start completion. After having confirmed the start completions of programs B, C, and E positioned in the lower hierarchies, program D transmits the notification of start completion to the operations management unit 72 of the expanded-functions operation management section 62, which had started program D, based on the acquired information of the hierarchical structure 50 through the function of reporting program start completion (2-14).

In FIGS. 15 and 16, a description is made of the flow of starting one expanded function 42 for better understanding the flow of starting the expanded functions 42. However, the actual image processing apparatus 10 issues instructions for simultaneously starting the installed expanded functions 42 after the power of the image processing apparatus 10 is turned on. Therefore, the expanded-functions operation management section 62 starts the programs positioned in the highest hierarchies of the respective expanded functions 42 based on the acquired information of the hierarchical structure 50 “Package-X→C:¥xxx/yyy/zzz/prog_x.dll.” Consequently, the programs are caused to start for each hierarchy based on the information of the hierarchical structure 50.

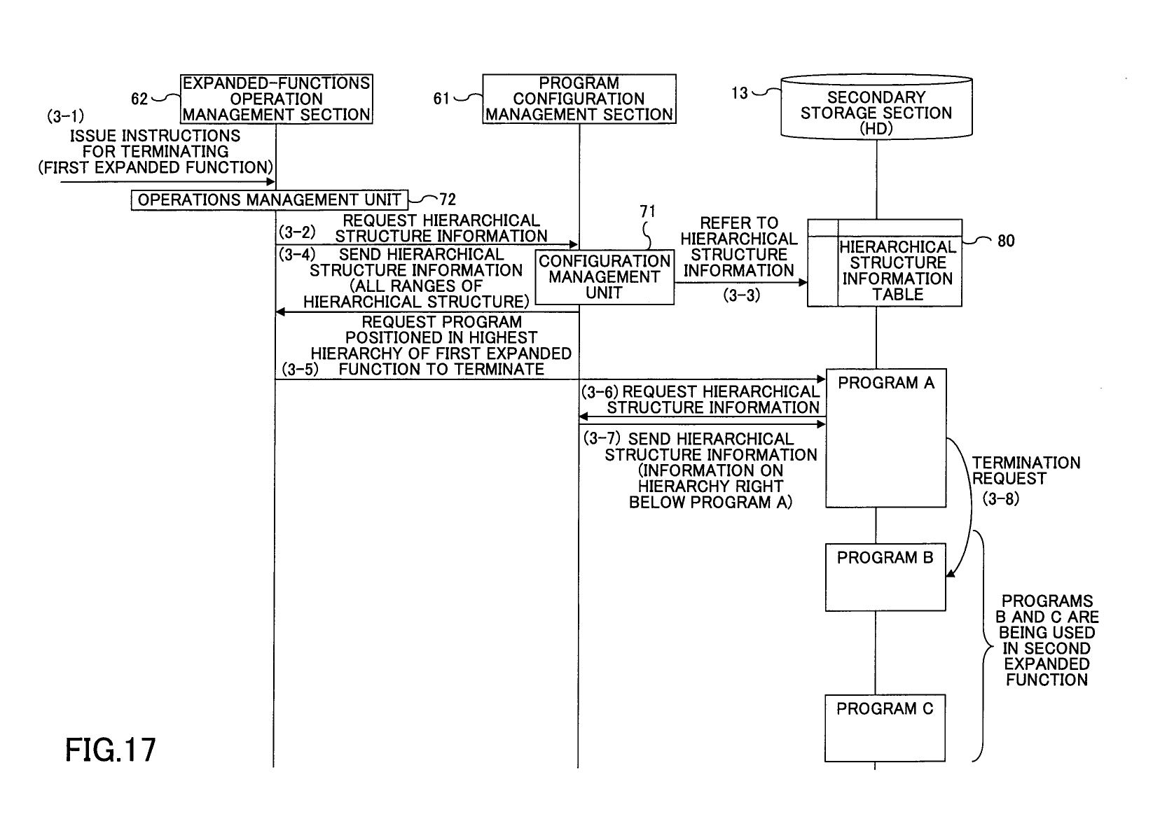

FIG. 17 is a sequence diagram showing the flow of terminating the first expanded function according to the first embodiment of the present invention.

First, the system of the image processing apparatus 10 issues instructions for terminating the first expanded function to the expanded-functions operation management section 62 (3-1).

Through the operations management unit 72, the expanded-functions operation management section 62 requests the program configuration management section 61 to acquire the information of the hierarchical structure 50 (3-2).

Through the configuration management unit 71, the program configuration management section 61 acquires the information of the hierarchical structure 50 from the hierarchical structure information table 80 stored in the secondary storage section 13 (3-3) and sends the acquired information of the hierarchical structure 50 to the expanded-functions operation management section 62 (3-4).

The expanded-functions operation management section 62 issues a termination request to program A positioned in the highest hierarchy of the first expanded function based on the received information of the hierarchical structure 50 “Package-1→D:¥xxx/yyy/zzz/prog_a.dll” (3-5).

Program A requests the program configuration management section 61 to acquire the information of the hierarchical structure 50 through the operations control function (3-6), and the program configuration management section 61 sends the information of the hierarchical structure 50 to program A through the configuration management unit 71 (3-7).

Program A issues a termination request to program B positioned in the hierarchy right below program A based on the received information of the hierarchical structure 50 “prog_a.dll→D:¥xxx/yyy/zzz/prog_b.dll” through the function of program termination request (3-8).

Program B receives the termination request from program A through the function of receiving a program termination request. However, through the operations control function, program B determines that its main process is being used by the other expanded function 42 (second expanded function). Therefore, program B rejects the termination request.

Accordingly, the programs whose main process is being used by the other expanded functions 42 like programs B and C are caused to terminate after having received, through the function of receiving a program termination request, the termination request from the expanded functions 42 which use the main process to the end.

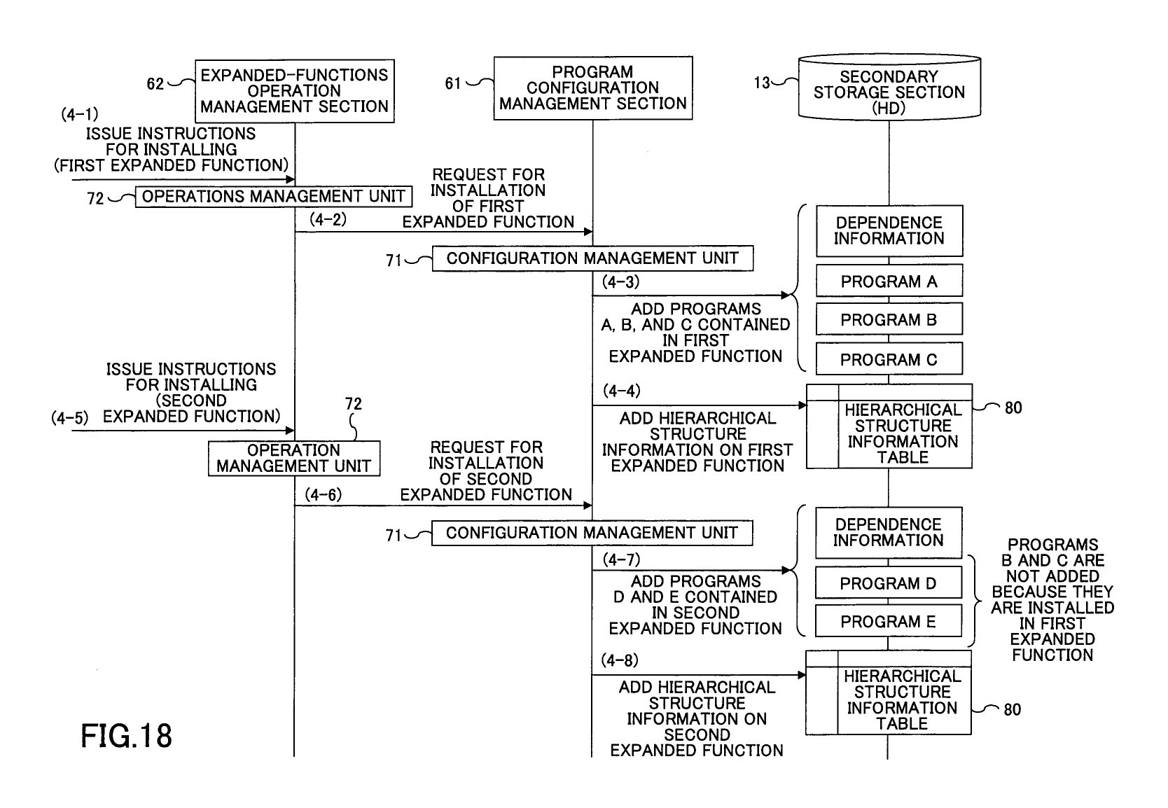

FIG. 18 is a sequence diagram showing the flow of installing the first and second expanded functions according to the first embodiment of the present invention.

First, when the first expanded function is installed, the system of the image processing apparatus 10 sends instructions for installing the first expanded function to the expanded-functions operation management section 62 (4-1).

The expanded-functions operation management section 62 requests the program configuration management section 61 to install the first expanded function through the operations management unit 72 (4-2).

Through the configuration management unit 71, the program configuration management section 61 acquires the first expanded-function package 30a for installation from the management server, memory cards, recording media, or the like and stores the programs A, B, and C of the expanded functions 42 and the dependence information 32 constituting the package in the secondary storage section 13 (4-3).

Next, the configuration management unit 71 updates the hierarchical structure information table 80 (adds the information on the programs A, B, and C of the new expanded functions 42) based on the dependence information 32 (4-4).

Furthermore, when the second expanded function is installed, the system of the image processing apparatus 10 sends instructions for installing the second expanded function to the expanded-functions operation management section 62 (4-5).

The expanded-functions operation management section 62 requests the program configuration management section 61 to install the second expanded function through the operations management unit 72 (4-6).

The program configuration management section 61 acquires the second expanded-function package 30b for installation from the management server, memory cards, recording media, or the like through the configuration management unit 71. Since the programs B and C of the expanded functions 42 constituting the package have been stored since the installation of the other expanded function 42 (first expanded function), new programs D and E and the dependence information 32 are stored in the secondary storage section 13 (4-7).

Next, the configuration management unit 71 adds the information on the programs D and E other than the programs B and C that has been stored since the installation of the other expanded function 42 (first expanded function) based on the dependence information 32 and updates the hierarchical structure information table 80 (4-8).

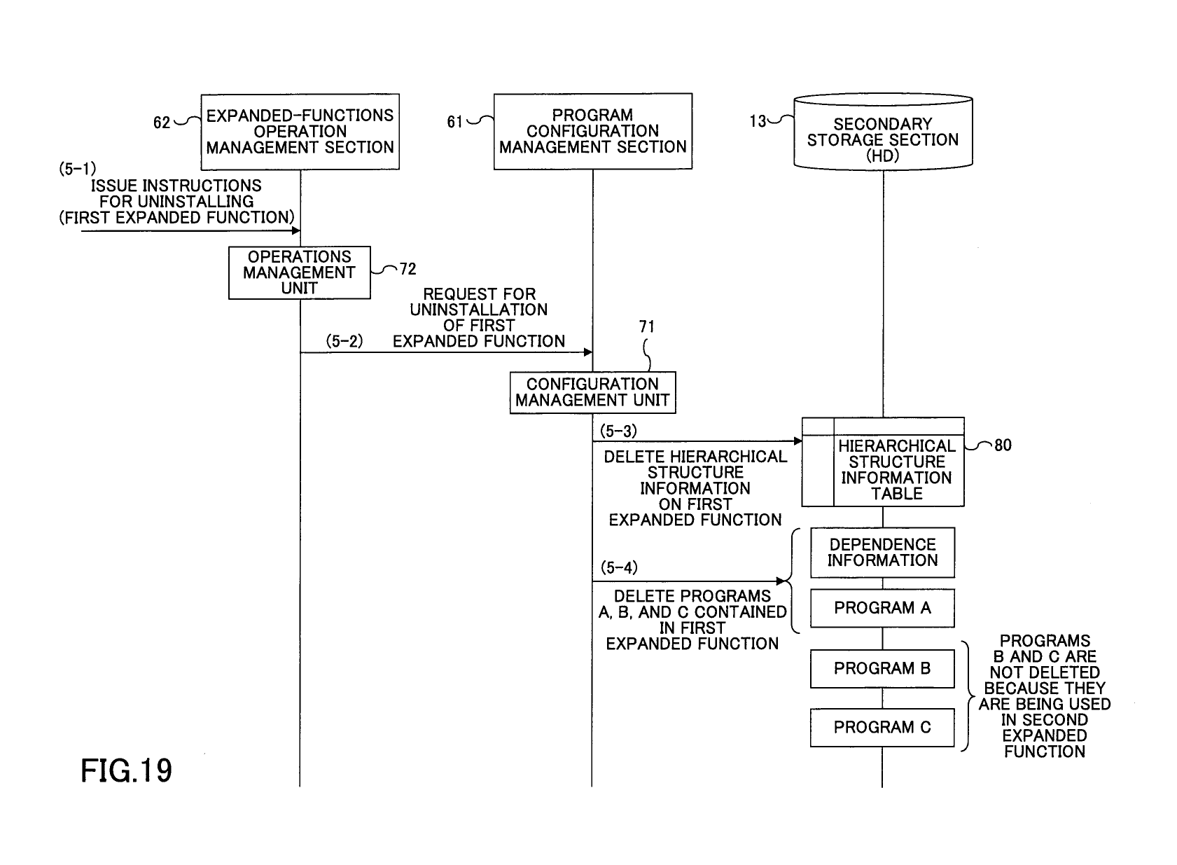

FIG. 19 is a sequence diagram showing the flow of uninstalling the first expanded function according to the first embodiment of the present invention.

First, the system of the image processing apparatus 10 sends instructions for uninstalling the first expanded function to the expanded-functions operation management section 62 (5-1).

The expanded-functions operation management section 62 requests the program configuration management section 61 to uninstall the first expanded function through the operations management unit 72 (5-2).

Through the configuration management unit 71, the program configuration management section 61 deletes only the information on program A other than the programs B and C being used by the other expanded function 42 (second expanded function) based on the dependence information 32 and the hierarchical structure information table 80 and updates the hierarchical structure information table 80 (5-3).

Next, the configuration management unit 71 deletes from the secondary storage section 13 the program A other than the programs B and C being used by the other expanded function 42 (second expanded function) based on the dependence information 32 and the updated hierarchical structure information table 80 and then deletes the dependence information 32 (5-4).

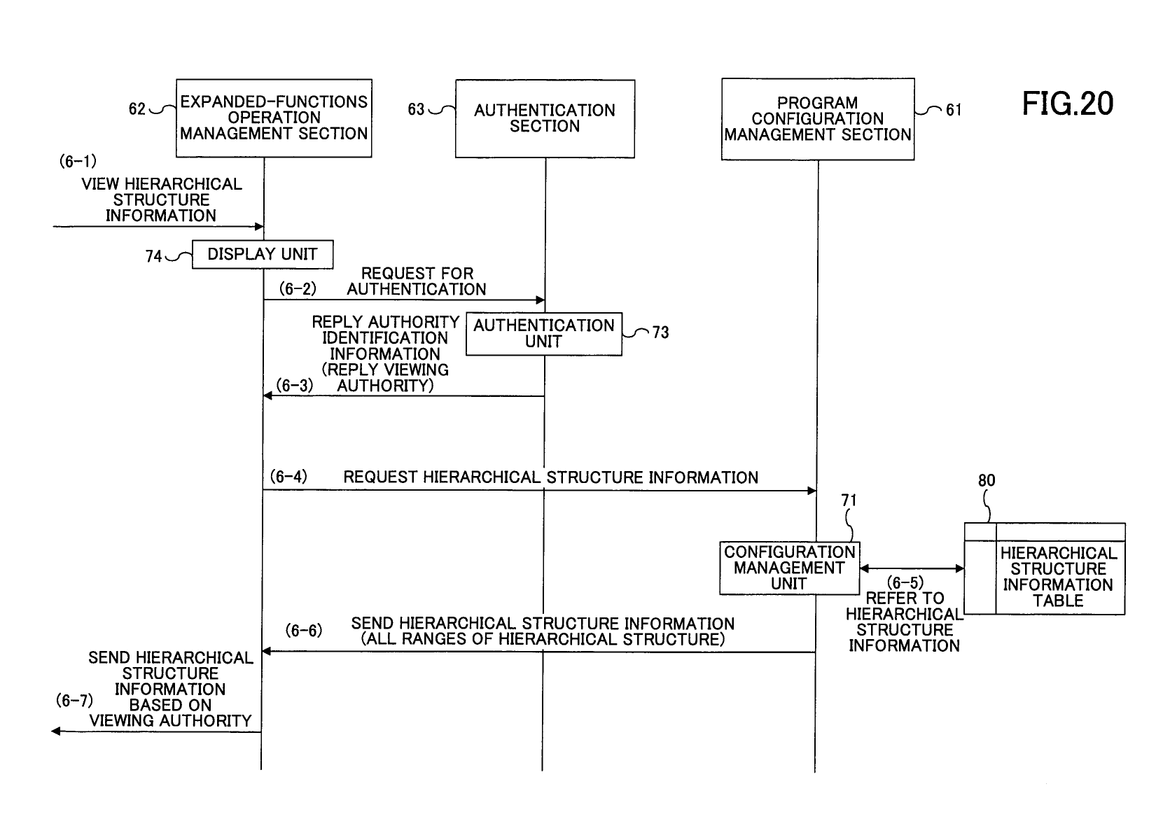

FIG. 20 is a sequence diagram showing the flow of displaying the information of the hierarchical structure 50 on the first and second expanded functions according to the first embodiment of the present invention.

First, the system of the image processing apparatus 10 sends instructions for viewing the information of the hierarchical structure 50 on the installed expanded functions 42 to the expanded-functions operation management section 62 (6-1).

Through the display unit 74, the expanded-functions operation management section 62 requests the authentication section 63 to authenticate the user who wishes to view the display unit 74 (6-2).

Through the authentication unit 73, the authentication section 63 determines the authentication of the user based on the requested authentication information of the user and replies with authority identification information indicating reference authority (viewing authority) that restricts the available range of information set for each user (6-3).

Next, the expanded-functions operation management section 62 requests the program configuration management section 61 to acquire the information of the hierarchical structure 50 through the display unit 74 (6-4).

Through the configuration management unit 71, the program configuration management section 61 acquires the information of the hierarchical structure 50 from the hierarchical structure information table 80 stored in the secondary storage section 13 (6-5) and sends the acquired information of the hierarchical structure 50 to the expanded-functions operation management section 62 (6-6).

Through the display unit 74, the expanded-functions operation management section 62 determines the available range of the information for the user relative to the acquired information of the hierarchical structure 50 based on the acquired authority identification information (reference authority (viewing authority)) and transmits the necessary information of the hierarchical structure 50 to the system to be displayed on the display screen (6-7).

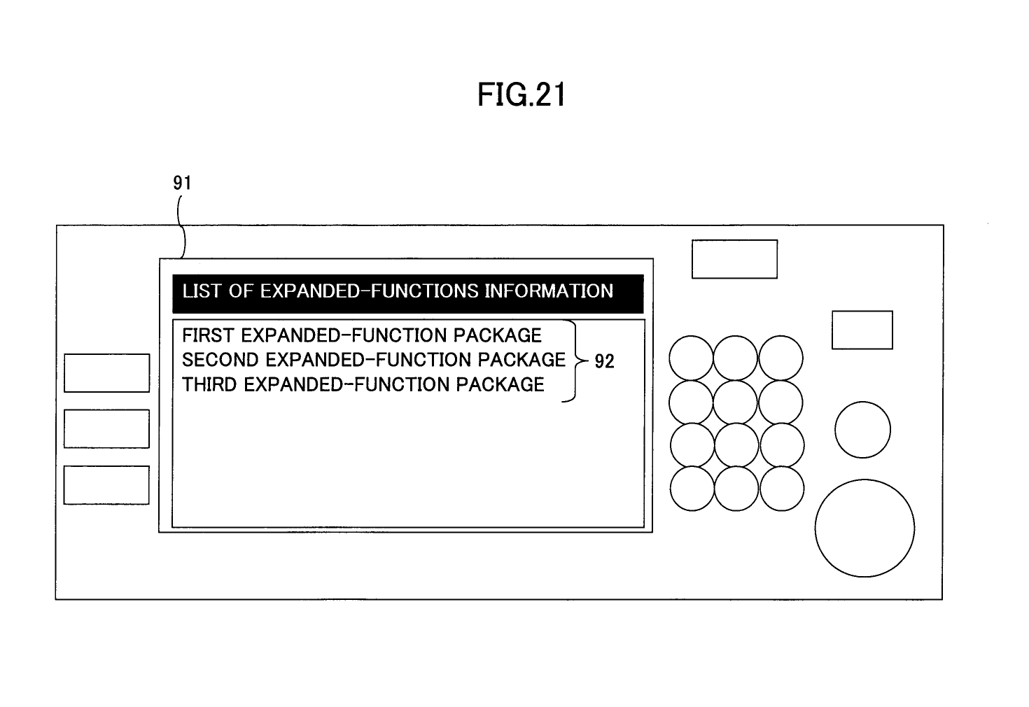

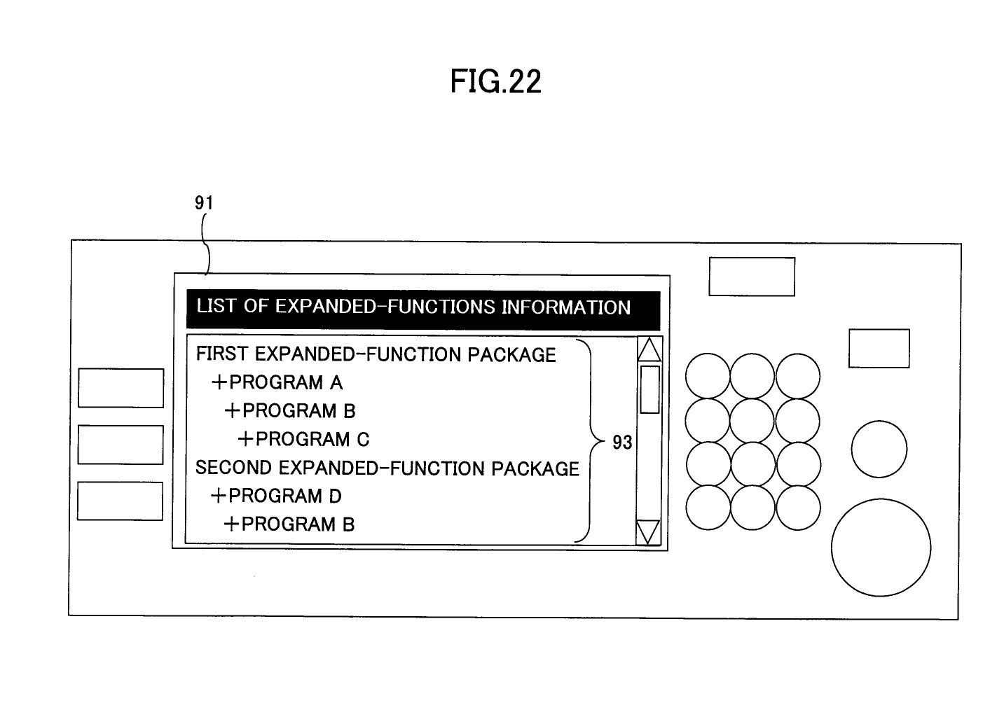

Referring next to FIGS. 21 and 22, a description is made below of a displayed example on the display section 12 when the flow of displaying the information of the hierarchical structure 50 as shown in FIG. 20 is performed.

FIG. 21 is an illustration showing a display example (when the user has low-level authority) of the hierarchical structure information on the first and second expanded functions according to the first embodiment of the present invention.

As shown in FIG. 21, in the case of the user having low-level authority identification information (reference authority (viewing authority)) sent from the authentication section 63, only the package name 92 among the information items of the hierarchical structure 50 relative to the installed expanded functions 42 is displayed on the display screen 91 of the display section 12.

FIG. 22 is an illustration showing a display example (when the user has high-level authority) of the hierarchical structure information on the first and second expanded functions according to the first embodiment of the present invention.

As shown in FIG. 22, in the case of the user having high-level authority identification information (reference authority (viewing authority)) sent from the authentication section 63, all the information items 92 of the hierarchical structure 50 relative to the installed expanded functions 42 are displayed on the display screen 91 of the display section 12.

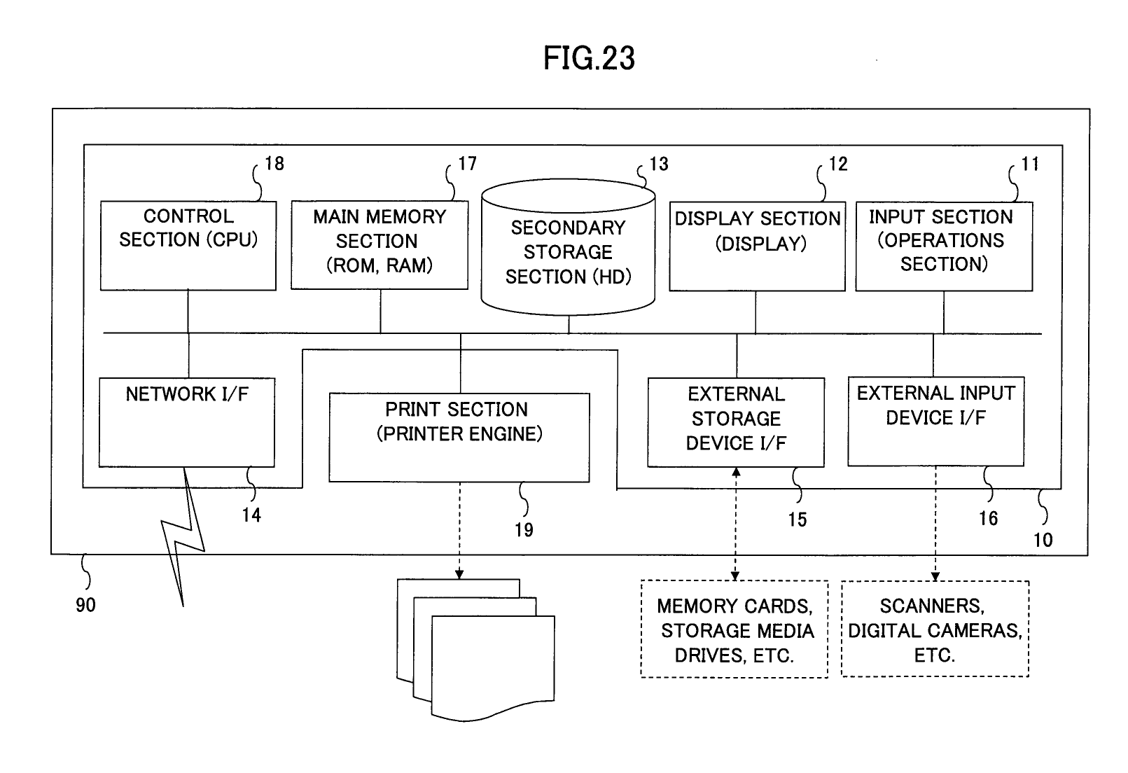

Referring last to FIG. 23, a description is made below of an image forming apparatus as a modified example of the present invention.

FIG. 23 is a block diagram showing a hardware configuration example according to the modified example of the present invention.

As shown in FIG. 23, the image forming apparatus 90 includes a print section 19 besides the hardware configuration of the image processing apparatus 10 as shown in FIG. 1.

The print section 19 is called a printer engine and composed of an image forming section that prints raster images (bit map images) generated after image processing (such as “filtering,” “resolution conversion,” “color matching,” “gamma correction,” and “gradation conversion”) on a sheet, a sheet feeding section that feeds a sheet to the image forming section, and a sheet ejecting section that ejects a printed sheet.

Accordingly, the print section 19 prints on a sheet the image data received from the image output function among the basic functions 41 (“the image input function,” “the image process function,” and “the image output function”) as shown in FIG. 2.

Therefore, an apparatus having the image processing apparatus 10 as represented by the image forming apparatus 90 may perform the embodiments of the present invention.

As described above, according to the first embodiment of the present invention, the image processing apparatus 10 manages the programs 31 of the expanded functions 42 having chain-reaction dependence through the respective function sections of the program configuration management section 61, the expanded-functions operation management section 62, and the authentication section 63, thereby achieving the embodiments of the present invention.

The program configuration management section 61 includes the configuration management unit 71 for installing or uninstalling the expanded-function package 30, stratifying the dependence between the programs 31 of the expanded functions 42 at the installation, and storing the information of the hierarchical structure 50 as stratified information in the hierarchical structure information table 80. Thereby, the program configuration management section 61 manages the programs of the installed expanded functions 42 and the information of the hierarchical structure 50.

The expanded-functions operation management section 62 includes the operations management unit 72 which starts or terminates the program positioned in the highest hierarchy of the expanded functions 42 based on the information of the hierarchical structure 50 managed in the hierarchical structure information table 80. Thereby, the expanded-functions operation management section 62 manages the operations of the programs 31 of the installed expanded functions 42.

As described above, when performing the starting or termination, the image processing apparatus 10 stratifies the dependence between the programs based on the dependence information 32, stores the hierarchical structure information as stratified information in the hierarchical structure information table 80 (generates the hierarchical structure information), and operates the programs 31 of the expanded functions 42 in accordance with the information of the hierarchical structure 50. Therefore, it is not necessary to perform centralized management of all the programs at one management section unlike conventional methods. Furthermore, it is possible to facilitate the management of the expanded functions 42 due to the low dependence between the programs 31 of the expanded functions 42 and the function sections that manage the programs.

Furthermore, since a method of managing the programs of the expanded functions 42 is simplified, it is possible to reduce processing work loads to manage programs when plural functions are expanded.

Accordingly, it is possible to achieve a system excellent in function expandability, function introduction flexibility, and product performance quality.

Furthermore, the expanded-functions operation management section 62 includes the display unit 74 through which is displayed the information of hierarchical structure 50 on the programs 31 of the installed expanded functions 42 on the display screen 91 of the display section 12 of the image processing apparatus 10.

The authentication section 63 includes the authentication unit 73 which authenticates whether the user is authorized to view (refer to) the information of the hierarchical structure 50 on the programs 31 of the installed expanded functions 42 and restricts the available range of the information of the hierarchical structure 50 for each user.

As described above, the image processing apparatus 10 can restrict the information of the hierarchical structure 50 on the programs 31 of the installed expanded functions 42 for each user to be displayed.

In the description of the present invention based on the first embodiment, “the path names of program data” managed in the hierarchical structure information table 80 as described therein are just examples showing storage locations among the information items of the hierarchical structure 50, and the present invention is not limited to this requirements.

For example, address values showing the storage destinations of programs may be used in stead of “the path names of program data.”

Furthermore, the secondary storage section 13 that stores the new expanded functions 42 as described in the above embodiment is just an example of storage devices, and the present invention is not limited to this requirement.

For example, non-volatile semiconductor memories such as memory cards may be used instead of the hard disk of the secondary storage section 13. In other words, there may be used one that can store the whole package of the expanded functions 42 for installation.

Furthermore, the authentication method with the input of a user ID and a password as described in the above embodiment is just an example of the method of authenticating the user, and the present invention is not limited to this requirement.

For example, if the image processing apparatus 10 is equipped with an IC card reader, the authentication of the user may be performed with an IC card. Besides, it may be performed based on the physical characteristics (such as the face or the fingerprint by which to specify an individual) of the user.

Last, the present invention is not limited to the requirements herein such as combining the configuration as described in the first embodiment with other elements.

In these regards, it is possible to modify them without departing from the scope of the present invention and appropriately set the same according to its application.

The present application is based on Japanese Priority Patent Application No. 2006-218426, filed on Aug. 10, 2006, the entire contents of which are hereby incorporated by reference.

What is claimed is:

1. An image processing apparatus in which plural programs mutually having dependence and dependence information indicating the dependence between the programs are stored, the apparatus comprising:
a configuration management unit that generates hierarchical structure information, where the dependence between the programs is stratified, based on the dependence information;
a hierarchical structure information table in which the hierarchical structure information is stored; and
an operations management unit that performs at least one of starting, termination, installation, and uninstallation of the programs by using the hierarchical structure information table.

2. The image processing apparatus according to claim 1, wherein, when a predetermined program is started, the operations management unit requests the configuration management unit to acquire the hierarchical structure information and starts the program that the predetermined program uses based on the acquired hierarchical structure information.

3. The image processing apparatus according to claim 1, wherein, when terminating a predetermined program, the operations management unit requests the configuration management unit to acquire the hierarchical structure information and requests the program that the predetermined program uses to terminate based on the acquired hierarchical structure information.

4. The image processing apparatus according to claim 1, wherein the operations management unit requests the configuration management unit to perform installation or uninstallation when installing or uninstalling, respectively, the programs.

5. The image processing apparatus according to claim 1, wherein the configuration management unit updates the hierarchical structure information table when the programs are installed or uninstalled.

6. The image processing apparatus according to claim 1, wherein the configuration management unit replies with the hierarchical structure information based on the hierarchical structure information table when an acquisition of the hierarchical structure information is requested.

7. The image processing apparatus according to claim 1, further comprising:
a display unit that displays information on the programs on a display screen; and
an authentication unit that authenticates whether a user is authorized to view the information on the programs; wherein
the display unit displays the information on the programs when the authentication unit succeeds in authentication.

8. The image processing apparatus according to claim 7, wherein the authentication unit determines reference authority indicating an available range of information among information items on the programs for each authenticated user.

9. The image processing apparatus according to claim 8, wherein the display unit displays the information on the programs within the range restricted based on the reference authority.

10. A program management method of an image processing apparatus in which plural programs mutually having dependence and dependence information indicating the dependence between the programs are stored, the method comprising:
a configuration management step of generating hierarchical structure information, where the dependence between the programs is stratified, based on the dependence information; and
an operations management step of performing at least one of starting, termination, installation, and uninstallation of the programs by using a hierarchical structure information table in which the hierarchical structure information is stored.

11. A management program for managing a plurality of programs in an image processing apparatus in which the plural programs mutually having dependence and dependence information indicating the dependence between the programs are stored, the program causing a computer to function as:
a configuration management unit that generates hierarchical structure information, where the dependence between the programs is stratified, based on the dependence information;
a hierarchical structure information table in which the hierarchical structure information is stored; and
an operations management unit that performs at least one of starting, termination, installation, and uninstallation of the programs by using the hierarchical structure information table.
